(19) United States
(12) Patent Application Publication
(10) Pub. No.: US 2016/0320489 A1
(43) Pub. Date: Nov. 3, 2016

(54) TARGET DEVICE FOR USE IN OPTICAL DETECTION OF AN OBJECT

(71) Applicant: BASF SE, Ludwigshafen (DE)

(72) Inventors: Robert SEND, Karlsruhe (DE); Ingmar BRUDER, Neuleiningen (DE); Henrike WONNEBERGER, Mannheim (DE)

(73) Assignee: BASF SE, Ludwigshafen (DE)

(21) Appl. No.: 15/105,489

(22) PCT Filed: Dec. 17, 2014
(86) PCT No.: PCT/EP2014/078155

§ 371 Date: Jun. 16, 2016

(30) Foreign Application Priority Data
Dec. 18, 2013 (EP) 13198075.7

(51) Int. Cl. G01S 17/42; G01S 7/481; G01S 17/66; G01S 17/00

(52) U.S. Cl. CPC G01S 17/42; G01S 17/003; G01S 7/4816; G01S 17/66

(57) ABSTRACT

A target device (110) for use in optical detection of at least one object (112) is disclosed. The target device (110) is adapted for at least one of being integrated into the object (112), being held by the object (112) or being attached to the object (112). The target device (110) has at least one reflective element (114) for reflecting a light beam (118). The target device (110) further has at least one color conversion element (116), the color conversion element (116) being adapted to change at least one spectral property of the light beam (118) during reflecting the light beam (118).

### FIELD OF THE INVENTION

The invention relates to a target device and a kit of target devices, for use in optical detection of at least one object. The invention further relates to an object comprising at least one target device, a detector device for detecting at least one object, a human-machine interface, an entertainment device, a tracking system and a method for optically detecting at least one position of at least one object. The invention further relates to a use of the target device according to the present invention for a purpose of use, selected from the group consisting of: a distance measurement, in particular in traffic technology; a position measurement, in particular in traffic technology; an entertainment application; a security application; a human-machine interface application; a tracking application; an imaging application; a camera application. However, other applications are also possible.

### BACKGROUND OF THE INVENTION

A large number of optical sensors and photovoltaic devices are known from the prior art. While photovoltaic devices are generally used to convert electromagnetic radiation, for example, ultraviolet, visible or infrared light, into electrical signals or electrical energy, optical detectors are generally used for picking up image information and/or for detecting at least one optical parameter, for example, a brightness.

Optical detection of an object generally is based on the use of one or more camera systems, such as on the use of camera systems having one or more imaging devices such as CCD chips and/or CMOS chips, wherein monochrome, multichrome or full-color imaging devices are known. Further, optical sensors may be used which are be based on the use of inorganic and/or organic sensor materials. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1.

A large number of detectors for detecting at least one object are known on the basis of such optical sensors. Such detectors can be embodied in diverse ways, depending on the respective purpose of use. Examples of such detectors are imaging devices, for example, cameras and/or microscopes. High-resolution confocal microscopes are known, for example, which can be used in particular in the field of medical technology and biology in order to examine biological samples with high optical resolution. Further examples of detectors for optically detecting at least one object are distance measuring devices based, for example, on propagation time methods of corresponding optical signals, for example laser pulses. Further examples of detectors for optically detecting objects are triangulation systems, by means of which distance measurements can likewise be carried out.

In WO 2012/110924 A1, the content of which is herewith included by reference, a detector for optically detecting at least one object is proposed. The detector comprises at least one optical sensor. The optical sensor has at least one sensor region. The optical sensor is designed to generate at least one sensor signal in a manner dependent on an illumination of the sensor region. The sensor signal, given the same total power of the illumination, is dependent on a geometry of the illumination, in particular on a beam cross section of the illumination on the sensor area. The detector furthermore has at least one evaluation device. The evaluation device is designed to generate at least one item of geometrical information from the sensor signal, in particular at least one item of geometrical information about the illumination and/or the object.

U.S. provisional applications 61/739,173, filed on Dec. 19, 2012, and 61/749,964, filed on Jan. 8, 2013, the full content of which is herewith included by reference, disclose a method and a detector for determining a position of at least one object, by using at least one transversal optical sensor and at least one longitudinal optical sensor. Specifically, the use of sensor stacks is disclosed, in order to determine a longitudinal position of the object with a high degree of accuracy and without ambiguity.

European patent application No. 13171900.7, filed on Jun. 13, 2013, the full content of which is herewith included by reference, discloses a detector device for determining an orientation of at least one object. The detector device comprises at least two beacon devices, the beacon devices being adapted to be at least one of attached to the object, held by the object and integrated into the object, the beacon devices each being adapted to direct light beams towards a detector, the beacon devices having predetermined coordinates in a coordinate system of the object. The detector device further comprises at least one detector adapted to detect the light beams traveling from the beacon devices towards the detector. The detector device further comprises at least one evaluation device, the evaluation device being adapted to determine longitudinal coordinates of each of the beacon devices in a coordinate system of the detector, the evaluation device being further adapted to determine an orientation of the object in the coordinate system of the detector by using the longitudinal coordinates of the beacon devices.

European patent application No. 13171901.5, filed on Jun. 13, 2013, the full content of which is herewith included by reference, discloses a detector for determining a position of at least one object. The detector comprises at least one optical sensor adapted to detect a light beam traveling from the object towards the detector, wherein the optical sensor has at least one matrix of pixels. The detector further comprises at least one evaluation device adapted to determine a number N of pixels of the optical sensor which are illuminated by the light beam. The evaluation device is further adapted to determine at least one longitudinal coordinate of the object by using the number N of pixels which are illuminated by the light beam.

European patent application No. 13171898.3, filed on Jun. 13, 2013, the full content of which is herewith included by reference, discloses an optical detector, comprising an optical sensor having a substrate and at least one photosensitive layer setup disposed thereon, the photosensitive layer setup having at least one first electrode, at least one second electrode and at least one photovoltaic material sandwiched in between the first electrode and the second electrode, wherein the photovoltaic material comprises at least one organic material, wherein the first electrode comprises a plurality of first electrode stripes and wherein the second electrode comprises a plurality of second electrode stripes, wherein the first electrode stripes and the second electrode stripes intersect such that a matrix of pixels is formed at intersections of the first electrode stripes and the second electrode stripes. The optical detector further comprises at least one readout device, the readout device comprising a plurality of electrical measurement devices being connected to the second electrode stripes and a switching device for subsequently connecting the first electrode stripes to the electrical measurement devices.

Despite the advantages implied by the above-mentioned devices and detectors, specifically by the detectors disclosed in WO 2012/110924 A1, U.S. 61/739,173, U.S. 61/749,964, EP 13171900.7, EP 13171901.5 and 13171898.3, several technical challenges remain. Thus, even though the position of an object may be determined with high accuracy, many applications additionally require information on an orientation of the object in space, specifically for objects having a prominent shape. Further, the detection of an object and/or the detection of a position or orientation of the object in many cases require the use of one or more target devices, also referred to as beacon devices, which may be implemented into the object and/or attached to the object and/or held by the object and which are adapted to direct a light beam towards the detector. The target devices may be active or passive target devices. In many applications, however, the use of a plurality of target devices is required, specifically in case an orientation of the object has to be determined. The latter application, however, generally implies the technical challenge of distinguishing between light beams originating from different targets devices. For this purpose, the target devices may be active target devices adapted for emitting distinguishable light beams, such as using different colors and/or different modulation frequencies. This implementation, however, in many cases requires the use of miniaturized light sources which may be implemented and/or attached to the object. These light sources generally significantly increase the costs of the overall technical setup. Further, the use of active target devices having light sources generally limit the types of objects to be detected to macroscopic objects having the capability of sustaining the presence of one, two or more light sources attached to the object held by the object or integrated into the object. Additionally, active target devices generally require one or more batteries or other energy sources which further limits potential applications of these target devices.

### Problem to be Solved

It is therefore an objective of the present invention to provide devices and methods for avoiding the above-mentioned shortcomings of known devices and methods for optically detecting at least one object. Specifically, a target device shall be disclosed which, in a cost-efficient way, allows for optically detecting the position of an object, including an orientation of the object, by avoiding significantly disturbing the overall shape of the object and by avoiding limiting the object to macroscopic objects capable of sustaining active light sources.

### SUMMARY OF THE INVENTION

This problem is solved by a target device, a kit, an object, a detector device, a human-machine interface, an entertainment device, a tracking system, a method and a use with the features of the independent claims. Preferred embodiments, which might be realized in an isolated fashion or in any arbitrary combination are listed in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which a solely and exclusively consists of B) and to a situation in which, besides B, one or more further elements are present in entity A, such as element C, elements C and D or even further elements.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a target device for use in optical detection of at least one object is disclosed, wherein the target device is adapted for at least one of being integrated into the object, held by the object or being attached to the object. The target device has at least one reflective element for reflecting a light beam, thereby generating a reflected light beam. The target device further has at least one color conversion element, the color conversion element being adapted to change at least one spectral property of the light beam during reflecting the light beam. The spectral property specifically may be selected from the group consisting of: a color of the light beam; a peak wavelength of a spectrum of the light beam; a polarization of the light beam. Thus, the color conversion element may be adapted to change a color of the light beam during reflecting the light beam.

Generally, as used herein and as will be outlined in further detail below, a target device, also referred to as a beacon device, generally is a device which is optically detectable by at least one detector, by being capable of directing at least one light beam towards the detector. Thus, generally, a position of the target device and/or at least one information relating to the position may be generated by the detector. As for the present invention, the target device is a reflective target device, the target device being capable of reflecting a primary light beam, thereby generating a reflected light beam. In the following, no verbal difference will be made between the primary light beam and the reflected light beam, even though the primary light beam impinging on the target device and the reflected light beam differ with regard to at least one spectral property, specifically with regard to at least one color.

As further used herein, a reflective element generally is an element capable of reflecting the light beam, specifically in a directed manner. Thus, the reflective element generally may be or may comprise an arbitrary means for reflecting the light, such as at least one reflective surface. As an example, the reflective element may comprise at least one reflective metal surface, such as at least one surface of a metal selected from the group consisting of aluminum, silver, chrome, copper or gold. Additionally or alternatively, other reflective surfaces may be used, such as one or more reflective surfaces of a polished material and/or of a semiconductor, such as a reflective selection surface. Therein, pure metals or metal alloys may be used. Further, additionally or alternatively, the reflective element may be or may comprise other reflective means, such as reflective multilayer systems, specifically inorganic transparent multilayer systems providing a plurality of interfaces which, in total, provide reflective properties. These types of inorganic multilayer systems are generally known in the art of optical mirrors. Thus, as an example, oxidic multilayer systems may be used, such as multilayer systems comprising one or more layers of magnesium oxide. Other embodiments are feasible.

As further used herein, a color conversion element generally is an element which is adapted to change at least one spectral property of the light beam during reflecting the light beam. Thus, specifically, a color of the light beam may be changed by the color conversion element during reflection, i.e. during interacting with the target device in general. The conversion of the at least one spectral property may take place immediately before reflection, during reflection or immediately after reflection. Thus, generally, the expression “during reflecting the light beam” refers to a time period during which the light beam interacts with the target device and, specifically, interacts with the color conversion element.

As further used herein, a color of the light beam generally refers to a spectral composition of the light beam. Specifically, the color of the light beam may be given in any arbitrary color coordinate system and/or in spectral units such as by giving a wavelength of a dominant peak of a spectrum of the light. Specifically, the color of the light beam may be given in CIE coordinates. Other embodiments are feasible. In case the light beam is a narrow-band light beam such as a laser light beam and/or a light beam generated by a semiconductor device such as a light-emitting diode, the peak wavelength of the light beam may be given to characterize the color of the light beam.

The color conversion element specifically may be one of a down-conversion color conversion element adapted for shifting the color of the light beam towards longer wavelengths and up-conversion color conversion element adapted for shifting the color of the light beam towards lower wavelengths. In case the color conversion element is a down-conversion color conversion element, the down-conversion color conversion element specifically may comprise at least one of: a perylene dye; a naphthalene dye, in particular a naphthalene benzimidazole; a squaraine dye; a diketopyrrolopyrrole dye; an acridine dye; a pyrene dye; triarylamines; rhodamines; fluoresceines; a rare-earth metal complex; a transition metal complex; an inorganic metal oxide pigment; an inorganic absorber; an inorganic pigment; a phthalocyanine dye; a porphyrine dye; an organic pigment; other fluorescent dyes and pigments known to the skilled person. In case the color conversion element is an up-conversion color conversion element, the up-conversion color conversion element specifically may comprise at least one rare earth metal complex.

The color conversion element specifically may comprise at least one dye. Thus, as an example, the color conversion element may comprise at least one dye absorbing in the ultraviolet and/or blue spectral region. The dye generally may be selected from the group consisting of an organic dye and an inorganic dye. As an example, one or more of a naphthalene derivative, a perylene derivative or a rare earth metal complex may be used.

The color conversion element specifically may comprise at least one color converter. Thus, as an example, the color conversion element may comprise at least one color converter as disclosed in WO 2012/152812 A1 and/or as disclosed in WO 2012/168395 A1—with or without the at least one barrier layer disclosed in these documents. As an example, the organic fluorescent colorant may be or may comprise at least one naphthalene dye and/or at least one perylene derivative. Further, the color conversion element generally may comprise at least one layer comprising at least one organic fluorescent colorant and at least one barrier layer having a low permeability to oxygen, as disclosed in WO 2012/152812 A1 and/or in WO 2012/168395 A1.

The target device specifically may comprise a layer setup having at least one reflective layer forming the reflective element or a part thereof and at least one color conversion layer forming the color conversion element or a part thereof, the color conversion layer being disposed onto the reflective layer, the color conversion layer comprising the at least one color conversion element. Other embodiments are feasible, such as embodiments in which the reflective element and the color conversion element are fully or partially identical or fully or partially integrated into one and the same element, such as by mixing one or more color conversion material into one or more reflective materials and/or by providing both reflective particles and color conversion particles within one and the same layer, such as within one and the same layer of a matrix material.

The reflective layer may contain one or more reflective elements, preferably one or more reflective elements selected from the group consisting of: angular reflectors; retro-reflectors; Luneburg-lenses; areal retro-reflectors.

The reflective element may comprise at least one flexible material, preferably a flexible material selected from the group consisting of: a flexible plastic material, a flexible textile, a glass bead tape, a micro-prismatic retro-reflective tape. As generally used herein, a flexible material is a material which may be deformed by ordinary forces occurring during handling the reflective element and/or the target device, preferably by hand, such as forces below 10 N.

The target device preferably is a passive target device without having an active light source. Thus, the target device may be kept very small. Specifically, the target device may have a diameter or equivalent diameter of 0.5 mm to 50 mm, preferably of 1.0 mm to 20 mm and more preferably of 5.0 mm to 10 mm. Additionally, however, one or more active light sources may be present. Alternatively, one or more other devices requiring electric energy may be present within the target device. Still, a passive target device is preferred, for the above-mentioned reasons.

The color conversion element specifically may comprise at least one matrix element and at least one color conversion material embedded into the matrix element. As an example, the matrix element comprises at least one transparent matrix material. Thus, the matrix material may have a transparency of at least 30%, preferably at least 50%, in the visible spectral range, such as in the blue spectral range. Specifically, the matrix element may comprise at least one matrix material selected from the group consisting of: a resin; a polymer, preferably a polymer selected from the group consisting of: polyethylene-terephthalate (PET), polystyrene, polyurethane, a synthetic or natural rubber, a polyester, a polycarbonate, a poly-acrylate, a polyamide, a silicone, a thermoplastic polymer, an elastic polymer; glass; silicon dioxide; a salt; an amorphous organic or inorganic phase; a crystalline organic or inorganic phase; a glue such as an epoxy glue. As an example, a perylene dye and/or a naphthalene dye, in particular naphthalene benzimidazole as a color conversion material or a part thereof may be embedded into a transparent plastic material as a matrix material, such as into polyethylene terephthalate (PET) and/or into polystyrene (PS).

The target device may further comprise at least one light-scattering material dispersed into the matrix material. Thus, as an example, the light-scattering material may comprise inorganic particles, specifically titanium dioxide.

The color conversion element specifically may comprise one or more of: an organic color conversion element, more preferably a polymer color conversion element; a color conversion pigment; a color conversion phosphor.

The target device may further comprise at least one attachment device adapted for attaching the target device to at least one object. The attachment device, as an example, may comprise at least one element selected from the group consisting of: an adhesive surface; a Velcro fastener; a strap; a hook; a clamp; a magnet; a ribbon; a belt; a button; a zipper; a rubber band; a suction cup; a fastener selected from the group consisting of: a clip, a clamp, a pin, a snap fastener, another kind of fastener known to the skilled person.

In a further aspect of the present invention, a kit comprising a plurality of the target devices according to the present invention is disclosed. Therein, at least two of the target devices have different color conversion elements. Thus, at least one first target device may have at least one first color conversion element, and at least one second target device may have at least one second color conversion element, wherein the first color conversion element and the second color conversion element differ with regard to their capability of changing the at least one spectral property of the light beam. Thus, one and the same light beam, when illuminating the first color conversion element will undergo a first change in at least one spectral property, and when illuminating the second color conversion element will undergo a second change in at least one spectral property, wherein the first change and the second change differ. Thus, as an example, the first color conversion element may be adapted to convert the color of the light beam into a first target color, and the second color conversion element may be adapted to convert the color of the light beam into a second target color, wherein the second target color is different from the first target color.

In a further aspect of the present invention, an object detectable by at least one optical detector is disclosed, the object comprising at least one target device according to the present invention, wherein the target device is at least one of integrated into the object, held by the object or attached to the object. The object specifically may comprise a plurality of the target devices, such as the kit according to the present invention, wherein at least two of the target devices have different color conversion elements. The plurality of the target devices specifically may comprise at least one first target device and at least one second target device, the first target device having a first color conversion element, wherein the first color conversion element is adapted to change a color of the light beam into a first target color, the second target device having a second color conversion element, wherein the second color conversion element is adapted to change a color of the light beam into a second target color, the second target color being different from the first target color.

The object generally may be an arbitrary object. Specifically, however, the object may be selected from the group consisting of: a garment, preferably a garment selected from the group consisting of a hat, a cap, a glove, a suit, a shirt, pants, a pullover, a jacket, a coverall, and overall, a coat or a mask; a musical instrument or a device for controlling one or more musical instruments, such as a stick, a drumstick, a plectrum, a fiddlestick or violin bow; a sports device, preferably a sports device selected from the group consisting of a racket, a bat; a toy, preferably a toy selected from the group consisting of a toy gun and a toy sword; a control device for controlling a machine, preferably a control device for controlling one or more of: a computer, a television set, another entertainment device, a remote-controlled toy such as a toy car, an airplane or a boat, more preferably a hand-held control device being holdable by a user; a mobile electronics device, preferably a mobile communication device such as a mobile phone, preferably a smart phone; a traffic sign; a traffic signal; a car; a bicycle; a motorbike; a forklift, such as a forklift truck; an object equipped with reflective material to ensure visibility due to high safety requirements.

In a further aspect of the present invention, a detector device for detecting at least one object is disclosed, comprising at least one target device according to the present invention, the target device being at least one of attached to the object, held by the object or integrated into the object, the detector device further comprising at least one optical detector adapted for detecting at least one light beam reflected by the target device, wherein the detector device is adapted for determining at least one position of the object by determining at least one position of the target device.

The detector device may further comprise at least one illumination source adapted for illuminating the target device. Thus, as an example, the at least one illumination source may be or may comprise at least one illumination source selected from the group consisting of: a laser, a light emitting diode, a light bulb, an incandescent light source. Additionally or alternatively, other illumination sources may be used, such as ambient light or sunlight, specifically direct sunlight.

The detector device specifically may comprise a plurality of the target devices, such as at least one kit according to the present invention, wherein at least two of the target devices have different color conversion elements. Thus, at least one first color conversion element of a first target device may be adapted to change a color of the light beam into a first color, wherein at least one second color conversion device of a second target device may be adapted to change the color of the light beam into a second color, wherein the second color is different from the first color. Thus, the target devices may be adapted for converting the color of a light beam emitted by one and the same illumination source into different colors, thereby allowing for identifying the respective target devices from which the converted light beams originate. The detector device may further comprise at least one color-sensitive element. The detector device may be adapted to distinguish the target devices by the color of light beams reflected by these target devices. Specifically, the color-sensitive element may comprise at least one element selected from the group consisting of: a filter, preferably a filter wheel; a prism; a grating; a dichroitic mirror; a color-sensitive detector element.

For potential setups of the optical detector, reference may e.g. be made to WO 2012/110924 A1. Thus, at least one detector having at least one optical sensor may be used, specifically at least one optical sensor being embodied as a dye-sensitized solar cell, more specifically as a solid dye-sensitized solar cell. As an example, the optical detector may comprise a stack of dye-sensitized solar cells, such as a stack of solid dye-sensitized solar cells. Additionally or alternatively, the optical detector may comprise one or more thin-film organic position sensitive detectors as disclosed in U.S. Pat. No. 6,995,445 B2. Thus, as an example, the optical detector may comprise a combination of one or more optical sensors as disclosed in WO 2012/110924 A1 and of one or more thin-film organic position sensitive detectors as disclosed in U.S. Pat. No. 6,995,445 B2. Specifically, the one or more optical sensors as disclosed in WO 2012/110924 A1 may be used for determining at least one longitudinal coordinate or z-coordinate of the object and/or a part thereof, by using the FiP-effect as disclosed in WO 2012/110924 A1, and the one or more thin-film organic position sensitive detectors as disclosed in U.S. Pat. No. 6,995,445 B2 may be used for determining at least one transversal coordinate or x-y-coordinate of the object and/or a part thereof, by using the transversal sensitivity as disclosed in U.S. Pat. No. 6,995,445 B2. However, other setups are feasible. Thus, generally, the at least one optical detector may comprise one or more of the detectors or optical detectors as disclosed in one or more of U.S. Pat. No. 6,995,445 B2, WO 2012/110924 A1, U.S. 61/739,173, U.S. 61/749,964, EP 13171900.7, EP 13171901.5 and 13171898.3, the full content of which is herewith included by reference.

Thus, the optical detector may comprise at least one longitudinal optical sensor, wherein the longitudinal optical sensor has at least one sensor region, wherein the longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein the optical detector further comprises at least one evaluation device, wherein the evaluation device is designed to generate at least one item of information on a longitudinal position of the object by evaluating the longitudinal sensor signal. For further details, reference may be made to WO 2012/110924 A1 and the so-called FiP-effect disclosed therein. The evaluation device specifically may be designed to generate the at least one item of information on the longitudinal position of the object from at least one predefined relationship between a geometry of the illumination and a relative positioning of the object with respect to the optical detector.

As outlined above, the optical detector specifically may have a plurality of the longitudinal optical sensors, wherein the longitudinal optical sensors are stacked. Thus, the longitudinal optical sensors may be stacked along at least one optical axis. Specifically, the longitudinal optical sensors may be arranged such that the light beam illuminates all longitudinal optical sensors, wherein at least one longitudinal sensor signal is generated by each longitudinal optical sensor, wherein the evaluation device is adapted to normalize the longitudinal sensor signals and to generate the information on the longitudinal position of the object independent from an intensity of the light beam.

The evaluation device may be adapted to generate the at least one item of information on the longitudinal position of the object by determining a diameter of the light beam from the at least one longitudinal sensor signal. Thus, the evaluation device may be adapted to compare the diameter of the light beam with known beam properties of the light beam in order to determine the at least one item of information on the longitudinal position of the object.

As e.g. disclosed in WO 2012/110924 A1, the longitudinal optical sensor may furthermore be designed in such a way that the longitudinal sensor signal, given the same total power of the illumination, is dependent on a modulation frequency of a modulation of the illumination. The optical detector specifically may comprise at least one modulation device for modulating the illumination. The modulation device may fully or partially be included within the optional illumination source and/or may fully or partially be interposed in between the illumination source and the object and/or may fully or partially be interposed in between the object and the at least one optical sensor of the detector. The modulation device, as an example, may be adapted to modulate an intensity of the light beam, preferably in a periodic fashion.

As outlined above, the optical detector may further comprise at least one transversal optical sensor, the transversal optical sensor being adapted to determine a transversal position of the light beam, the transversal position being a position in at least one dimension perpendicular an optical axis of the detector. The transversal optical sensor may be adapted to generate at least one transversal sensor signal, wherein the evaluation device may be further adapted to generate at least one item of information on a transversal position of the object by evaluating the transversal sensor signal. For potential embodiments of the at least one transversal optical sensor, reference may e.g. be made to one or more of U.S. 61/739,173, U.S. 61/749,964 or U.S. Pat. No. 6,995,445 B2.

The at least one transversal optical sensor specifically may fully or partially be embodied as a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes, wherein the transversal optical sensor has a sensor region, wherein the at least one transversal sensor signal indicates a position of the light beam in the sensor region. Specifically, electrical currents through the partial electrodes may be dependent on a position of the light beam in the sensor region. The transversal optical sensor may be adapted to generate the transversal sensor signal in accordance with the electrical currents through the partial electrodes. The detector device may be adapted to derive the information on the transversal position of the object from at least one ratio of the currents through the partial electrodes. Specifically, the photo detector may be a dye-sensitized solar cell. The first electrode may at least partially be made of at least one transparent conductive oxide, and the second electrode may at least partially be made of an electrically conductive polymer, preferably a transparent electrically conductive polymer.

In a further aspect of the present invention, a human-machine interface for exchanging at least one item of information between a user and a machine is disclosed. The human-machine interface comprises at least one detector device according to the present invention. The human-machine interface is designed to generate at least one item of geometrical information of the user by means of the detector device. The human-machine interface is designed to assign to the geometrical information at least one item of information. For further definitions, details and potential embodiments of the human-machine interface or parts thereof, reference may e.g. be made to one or more of WO 2012/110924 A1, U.S. 61/739,173, U.S. 61/749,964, EP 13171900.7, EP 13171901.5 and 13171898.3.

In a further aspect of the present invention, an entertainment device for carrying out at least one entertainment function is disclosed. The entertainment device comprises at least one human-machine interface according to the present invention. The entertainment device is designed to enable at least one item of information to be input by a player by means of the human-machine interface. The entertainment device is further designed to vary the entertainment function in accordance with the information. For further definitions, details and potential embodiments of the entertainment device or parts thereof, reference may e.g. be made to one or more of WO 2012/110924 A1, U.S. 61/739,173, U.S. 61/749,964, EP 13171900.7, EP 13171901.5 and 13171898.3.

In a further aspect of the present invention, a tracking system for tracking the position of at least one movable object is disclosed. The tracking system comprises at least one detector device according to the present invention. The tracking system further comprises at least one track controller, wherein the track controller is adapted to track a series of positions of the object, each position comprising at least one item of information on a transversal position of the object at a specific point in time and at least one item of information on a longitudinal position of the object at a specific point in time. For further definitions, details and potential embodiments of the tracking system or parts thereof, reference may e.g. be made to one or more of WO 2012/110924 A1, U.S. 61/739,173, U.S. 61/749,964, EP 13171900.7, EP 13171901.5 and 13171898.3.

In a further aspect of the present invention, a method for optically detecting at least one position of at least one object is disclosed. The method comprises the following method steps, which may be performed in the given order or in a different order. Further, additional method steps might be provided which are not listed. Further, two or more or even all of the method steps might be performed at least partially simultaneously. Further, two or more or even all of the method steps might be performed twice or even more than twice, repeatedly.

The method comprises using at least one target device according to the present invention. The target device is at least one of attached to the object, held by the object or integrated into the object. The method further comprises detecting at least one light beam reflected by the target device. The method further comprises determining at least one position of the object by determining at least one position of the target device. The method may further comprise illuminating the object with illumination light.

The method may further comprise using a plurality of the target devices, wherein at least two of the target devices have different color conversion elements. The at least one first color conversion element of a first target device specifically may be adapted to change a color of the light beam into a first color, and the at least one second color conversion device of a second target device specifically may be adapted to change the color of the light beam into a second color, wherein the second color is different from the first color. The method may further comprise distinguishing the target devices by the color of light beams reflected by these target devices.

In a further aspect of the present as mentioned, the use of a target device according to the present invention is disclosed, for a purpose of use, selected from the group consisting of: a distance measurement, in particular in traffic technology; a position measurement, in particular in traffic technology; an entertainment application; a security application; a human-machine interface application; a tracking application; an imaging application; a camera application; a manufacturing process; a packaging process.

As outlined above, the detector device preferably may comprise one or more evaluation devices adapted for performing one or more calculations and/or evaluations, such as for determining the at least one position, such as the at least one orientation, of the object, by evaluating one or more detector signals of the at least one detector. Thus, the evaluation device may comprise one or more data processing devices and/or one or more computers. As an example, the evaluation device may comprise one or more processors. Further, the evaluation device may comprise data storage means, such as one or more volatile data storage is and/or one or more non-volatile data storages. Further, the evaluation device may comprise one or more user interfaces, such as one or more devices adapted for a user to input information and/or commands, and/or one or more devices adapted for displaying or providing information to a user.

In the context action, a position generally may be an arbitrary coordinate or combination of coordinates or any other information indicating one or more of a spatial position of the object or a part thereof, an orientation of the object or a part thereof or a spatial configuration of the object or a part thereof.

Thus, specifically, the target device, the kit, the object, the detector device and the method may be adapted for determining at least one orientation of the object or a part thereof, by determining the position of at least two of the target devices being at least one half attached to the object, held by the object or integrated into the object in different positions. By determining coordinates of the target devices by using the detector device, the orientation of the object or a part thereof may be determined.

Thus, as outlined above, at least two target devices may be used, the target devices being at least one of attached to the object, held by the object or integrated into the object. The target devices each may direct light beams towards the detector, such as in an emission step. The target devices may have predetermined coordinates in a coordinate system of the object.

Further, light beams traveling from the target devices towards the detector may be detected by the detector, such as in a detection step. Longitudinal coordinates of each of the target devices may be determined in a coordinate system of the detector, and an orientation of the object may be determined in the coordinate system of the detector by using the longitudinal coordinates of the target devices.

The coordinate system of the object generally may be a coordinate system having at least one point, preferably an origin of the coordinate system, attached to at least one point of the object.

Thus, preferably, the coordinate system of the object moves and/or rotates with the object. Similarly, the coordinate system of the detector may be a coordinate system having at least one point, preferably an origin of the coordinate system, attached to at least one point of the detector. Generally, the coordinate systems preferably may be Cartesian coordinate systems. Additionally or alternatively, however, other types of coordinate systems may be used, such as polar coordinate systems and/or spherical coordinate systems.

The orientation of the object preferably may be provided by using one or more orientation angles. As the skilled person will recognize, several systems are known in the art for determining an orientation of an object, such as in the art of gyroscopes. Specifically, the evaluation device may be adapted to determine the orientation of the object by providing at least two orientation angles. Preferably, the evaluation device may be adapted to determine the orientation of the object by providing at least two or at least three orientation angles.

As an example for orientation angles generally known in the art, the evaluation device may be adapted to determine the orientation of the object by providing at least one angle combination selected from the group consisting of: a yaw angle (ψ) and a pitch angle (Θ); a yaw angle (ψ), a pitch angle (Θ) and a roll angle (φ); Euler angles. Examples will be given in further detail below.

As outlined above, the detector device comprises at least one detector. The detector itself may comprise a plurality of components, such as a plurality of individual or combine detectors or sensors. Thus, the at least one detector may comprise at least one longitudinal optical sensor, wherein the longitudinal optical sensor has at least one sensor region, wherein the longitudinal optical sensor is designed to generate longitudinal sensor signals in a manner dependent on an illumination of the sensor region by the light beams, wherein the longitudinal sensor signals, given the same total power of the illumination, are dependent on a beam cross-section of the light beams in the sensor region.

For potential details of this property of the longitudinal optical sensor providing sensor signals which, given the same total power of the illumination, are dependent on the beam cross-section of the light beams in the sensor region, reference may be made to WO 2012/110924 A1, the full content of which is here with included by reference, and the so-called FiP-effect disclosed therein. Further, reference may be made to one or more of U.S. 61/739,173, U.S. 61/749,964, EP 13171900.7, EP 13171901.5 and 13171898.3, the full content of which is herewith included by reference.

The evaluation device may be designed to determine the longitudinal coordinates of the target devices by evaluating the longitudinal sensor signals. The longitudinal optical sensor may be a transparent optical sensor. Other embodiments are possible. The longitudinal optical sensor specifically may comprise at least one dye-sensitized solar cell. Other embodiments are possible.

The longitudinal optical sensor may comprise at least one first electrode, at least one n-semiconducting metal oxide, at least one dye, at least one p-semiconducting organic material, preferably a solid p-semiconducting organic material, and at least one second electrode. The first electrode, the second electrode or both the first electrode and the second electrode may be transparent. Other embodiments are possible.

The evaluation device may be designed to determine the longitudinal coordinates of the target devices from at least one predefined relationship between the geometry of the illumination and a relative positioning of the respective target device with respect to the detector.

The detector may have a plurality of the longitudinal optical sensors. Specifically, the longitudinal optical sensors may be stacked, thereby preferably forming a longitudinal optical sensor stack. The longitudinal optical sensors may be arranged such that a light beam traveling from at least one of the target devices to the detector illuminates all longitudinal optical sensors. The at least one longitudinal sensor signal may be generated by each longitudinal optical sensor. The evaluation device may be adapted to normalize the longitudinal sensor signals and to generate the at least one longitudinal coordinate of the respective target device independent from an intensity of the light beam, at least for intensities>0.

The evaluation device may be adapted to determine the longitudinal coordinate of each target device by determining a diameter of the respective light beam from the at least one longitudinal sensor signal. Thus, the evaluation device may be adapted to compare the diameter of the light beam with known beam properties of the light beam in order to determine the longitudinal coordinate. As will be outlined in further detail below, the known beam properties of the light beam specifically may be Gaussian properties, such as a known relationship between a longitudinal coordinate and the beam waist of the light beam.

The longitudinal optical sensor may furthermore be designed in such a way that the longitudinal sensor signal, given the same total power of the illumination, is dependent on a modulation frequency of a modulation of the illumination. Examples will be given in further detail below.

The at least one detector of the detector device may further comprise at least one transversal optical sensor, the transversal optical sensor being adapted to determine a transversal position of the light beams, the transversal position being a position in at least one dimension perpendicular an optical axis of the detector, the transversal optical sensor being adapted to generate transversal sensor signals. Transversal optical sensors of this type are generally known in the art, such as in U.S. Pat. No. 6,995,445 B2. Thus, one or more transversal optical sensors as generally disclosed in U.S. Pat. No. 6,995,445 B2 may be used. Additionally or alternatively, one or more of the transversal optical sensors as disclosed in U.S. provisional applications 61/739,173 and 61/749,964, the full content of which is herewith included by reference, may be used.

The evaluation device may be designed to determine at least one transversal coordinate for at least one of the target devices, preferably for a plurality of the target devices and most preferably for all of the target devices, by evaluating the transversal sensor signals.

The transversal optical sensor may be a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes, wherein the transversal optical sensor has a sensor region, wherein the at least one transversal sensor signal indicates a position of the light beam in the sensor region. Electrical currents through the partial electrodes may be dependent on a position of the light beam in the sensor region, wherein the transversal optical sensor is adapted to generate the transversal sensor signal in accordance with the electrical currents through the partial electrodes. The detector device may be adapted to derive the transversal coordinate from at least one ratio of the currents through the partial electrodes. Other embodiments are feasible.

The at least one optional photo detector of the at least one optional transversal optical sensor specifically may be a dye-sensitized solar cell. Other embodiments are feasible. The first electrode of the at least one optional photo detector of the at least one optional transversal optical sensor may at least partially be made of at least one transparent conductive oxide, wherein the second electrode at least partially is made of an electrically conductive polymer, preferably a transparent electrically conductive polymer. Other embodiments are feasible. The transversal optical sensor may be an opaque or, preferably, a transparent optical sensor.

The at least one optional transversal optical sensor and the at least one optional longitudinal optical sensor of the detector preferably are stacked along the optical axis such that a light beam travelling along the optical axis both impinges on the transversal optical sensor and on the longitudinal optical sensor.

The detector device may furthermore comprise at least one illumination source. Thus, the detector device may comprise at least one illumination source adapted to illuminate the at least one target device. As outlined above, the at least one target device comprises at least one reflective element and, thus, may be adapted to generate one or more reflected light beams directed towards the detector. Thus, the target devices are fully or partially embodied as so-called passive target devices. Additionally, however, one, more than one or even all of the target devices may be equipped with at least one illumination source adapted to emit light, thereby being self-emissive target devices.

In a further aspect of the present invention, a detector system is disclosed. The detector system comprises at least one detector device according to the present invention, such as according to one or more of the embodiments disclosed above or disclosed in further detail below. The detector system further comprises at least one object, wherein the at least one target device, preferably a plurality of at least two or at least three target devices, is at least one of attached to the object, held by the object or integrated into the object.

The object preferably may be a rigid object. Thus, preferably, the object is fully or partially rigid. As used herein, the term rigid refers to the fact that, in the coordinate system of the object, each point of the object or at least each point of at least one region of the object remains at a constant position which does not change with time. Still, other embodiments are feasible. Thus, the object may fully or partially be embodied as a flexible object and/or an object which fully or partially may change its shape. In the latter case, preferably, three or more target devices are used. In case an object is used which fully or partially is flexible and/or which fully or partially may change its shape, typical movements and/or changes of shape of the object may be known and/or may be predetermined. Thus, as an example, typical movements of an arm and/or other body parts are known and may be implemented.

As will be outlined in further detail below, the present invention preferably may be applied in the field of human-machine interfaces, in the field of sports and/or in the field of computer games. Thus, preferably, the object may be selected from the group consisting of: an article of sports equipment, preferably an article selected from the group consisting of a racket, a club, a bat; an article of clothing such as a hat, a shoe, a glove, a shirt, a pair of pants, a suit, a coverall, and overall or a headband. Other embodiments are feasible. Additionally or alternatively, however, as will be outlined in further detail below, the object may be a living object or a part of a living object, such as a body part of a user. Thus, as an example, the object may be selected from the group consisting of a hand, an arm, a head, a torso, a leg or a foot and/or one or more parts thereof.

As used herein, the object generally may be an arbitrary object, chosen from a living object and/or a non-living object, wherein combinations of at least one living object and at least one non-living object are feasible. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

With regard to the coordinate system of the detector, the detector may constitute a coordinate system in which an optical axis of the detector forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The position, possibly including the orientation, of the object may be determined in various ways, by using the at least two longitudinal coordinates of the at least two target devices and, optionally, one or more additional items of information relating to one or more or all of the target devices, such as at least one transversal coordinate for at least one of the target devices, preferably for at least two of the target devices or all of the target devices. As outlined above, the evaluation device may be adapted to determine the orientation of the object by providing at least one angle combination selected from the group consisting of: a yaw angle (ψ) and a pitch angle (Θ); a yaw angle (ψ), a pitch angle (Θ) and a roll angle (φ); Euler angles.

For determining the orientation, in a most simple case, a difference in the longitudinal coordinates of the target devices, i.e. a difference in the z-coordinates of the target devices, may be sufficient. Thus, as an example, in case the z-coordinates of at least two target devices are found to be identical, it may be determined that a plane of the object containing the at least two target devices is oriented perpendicular to the optical axis of the detector. Similarly, in case the z-coordinates of two target devices differ by Δz, by using a known distance d between the target devices in the coordinate system of the object and by using a simple trigonometric function (such as sin Θ=Δz/d or a similar function), an angle between a connection line between the target devices and the optical axis may be determined. Generally, specifically for rigid objects having an arbitrary shape and having or being connected to a plurality of at least two, preferably at least three target devices, it is possible to find a transformation allowing to determine at least one item of information relating to the orientation of the object in the coordinate system of the detector, once the at least two longitudinal coordinates of the at least two target devices, preferably the at least three longitudinal coordinates of the at least three target devices, and, preferably, additional information, are known. Further examples of transformations will be given in detail below.

As an example, the transformation may be performed by using transformation matrices. Additionally or alternatively, other algorithms for determining at least one item of information regarding the orientation of the object may be used.

As used herein, a detector device for determining an orientation of at least one object generally is a device adapted for providing at least one item of information on the orientation of the at least one object and/or a part thereof. Thus, the orientation may refer to an item of information fully describing the orientation of the object or a part thereof in the coordinate system of the detector or may refer to a partial information, which only partially describes the orientation, such as with regard to a specific plane in the coordinate system of the detector. The detector, which is part of the detector device, generally is a device adapted for detecting light beams, such as the light beams traveling from the target devices towards the detector.

The detector device, as outlined above, comprises a plurality of components, i.e. at least the at least two target devices, the detector and the evaluation device. Preferably, the at least two target devices may be handled independently from the detector, thereby forming independent entities. The evaluation device and the detector, however, may fully or partially be integrated into a single device. Thus, generally, the evaluation device also may form part of the detector. Alternatively, the evaluation device and the detector may form separate devices. The detector device may comprise further components.

The detector may be a stationary device or a mobile device. Further, the detector may be a stand-alone device or may form part of another device, such as a computer, a vehicle or any other device. Further, the detector may be a hand-held device. Other embodiments of the detector are feasible.

The at least one optional transversal optical sensor and the at least one optional longitudinal optical sensor may at least partially be integrated into one optical sensor. Alternatively, at least one longitudinal optical sensor may be provided which is separate from at least one transversal optical sensor. Further, the at least one evaluation device may be formed as a separate evaluation device independent from the at least one transversal optical sensor and the at least one longitudinal optical sensor, but may preferably be connected to the at least one optional transversal optical sensor and the at least one optional longitudinal optical sensor, in order to receive the transversal sensor signal and/or the longitudinal sensor signal. Alternatively, the at least one evaluation device may fully or partially be integrated into the at least one transversal optical sensor and/or the at least one longitudinal optical sensor.

As used herein, the term transversal optical sensor generally refers to a device which is adapted to determine a transversal position of at least one light beam traveling from the object to the detector. With regard to the term transversal position, reference may be made to the definition given above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible.

For potential embodiments of the transversal optical sensor, reference may be made to the position sensitive organic detector as disclosed in U.S. Pat. No. 6,995,445 and US 2007/0176165 A1. However, other embodiments are feasible and will be outlined in further detail below.

As outlined above, one or more target devices may be used. Thus, in an embodiment, at least two target devices may be used, wherein, preferably, the target devices have different color conversion elements, in order to distinguish the light beams reflected by the respective target devices. Thus, the reflected light beams reflected by different target devices may have different spectral properties, such as different colors. The detector device, specifically the detector, may have color-sensitive elements adapted to distinguish the target devices by the color of the light beams reflected by these target devices. As used herein, a color sensitive-element generally refers to an element which is adapted to provide an action or a response depending on at least one spectral property of a light beam. Thus, the color-sensitive element may be or may comprise an optical sensor having a spectral response depending on the color of the light beam. Additionally or alternatively, the color-sensitive element may be or may comprise a spectral separation element, such as at least one of an optical filter, a grating, a prism, a dichroitic mirror or any other type of optical separation element adapted for separating light beams or components thereof by their color.

Thus, generally, the detector device may be adapted to distinguish the light beams reflected by different target devices. Thus, preferably, two or more target devices may be present, being one or more of attached to the object, integrated into the object or held by the object.

By detecting and distinguishing the light beams reflected by the different target devices, an orientation of the object may be determined. Thus, the orientation may be determined by using two or more target devices according to the present invention and preferably by using the method and/or the detector device as disclosed in European patent application No. 13171900.7, filed on Jun. 13, 2013, the full content of which is herewith included by reference. Other embodiments are feasible.

In case only two target devices are present, preferably, at least one further item of information is used to determine the orientation. Thus, as an example, as at least one further item of information, at least one transversal coordinate of at least one of the target devices may be used, as will be outlined in further detail below, preferably transversal coordinates of both of the target devices or of all of the target devices. In case three or more target devices are present, the longitudinal coordinates of the three or more target devices generally are sufficient for determining the orientation of the object. Thus, as an example, from the differences in the longitudinal coordinates of the three or more target devices, the orientation, such as a rotation, of the object may be determined, as will be outlined in further detail below. Specifically, by using the predetermined coordinates of the target devices in the coordinate system of the object, and by determining the longitudinal coordinates of the target devices in the coordinate system of the detector, a coordinate transformation may be performed and/or the above-mentioned orientation angles may be determined, by using the evaluation device. Thus, the evaluation device may be adapted to use one or more transformation algorithms for transforming the longitudinal coordinates of the target devices and, optionally, one or more additional items of information, into at least one item of information regarding the orientation of the object in the coordinate system of the detector.

As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the transversal sensor signal and/or the longitudinal sensor signal, such as one or more AD-converters and/or one or more filters. Further, the evaluation device may comprise one or more data storage devices. Further, the evaluation device may comprise one or more interfaces, such as one or more wireless interfaces and/or one or more wire-bound interfaces.

The at least one evaluation device may be adapted to perform at least one computer program, such as at least one computer program performing or supporting the step of determining the longitudinal coordinates of each of the target devices in the coordinate system of the detector and/or of determining the orientation of the object in the coordinate system of the detector by using the longitudinal coordinates of the target devices. As an example, one or more algorithms may be implemented which, by using the transversal sensor signals and/or the longitudinal sensor signals as input variables, may perform a predetermined transformation into the orientation of the object.

As outlined above, preferably, the at least one optional transversal optical sensor is a photo detector having at least one first electrode, at least one second electrode and at least one photovoltaic material, wherein the photovoltaic material is embedded in between the first electrode and the second electrode. As used herein, a photovoltaic material generally is a material or combination of materials adapted to generate electric charges in response to an illumination of the photovoltaic material with light.

As used herein, the term light generally refers to electromagnetic radiation in one or more of the visible spectral range, the ultraviolet spectral range and the infrared spectral range. Therein, the term visible spectral range generally refers to a spectral range of 380 nm to 780 nm. The term infrared spectral range generally refers to electromagnetic radiation in the range of 780 nm to 1 mm, preferably in the range of 780 nm to 3.0 micrometers. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term light beam generally refers to an amount of light emitted and/or reflected into a specific direction. Thus, the light beam may be a bundle of the light rays having a predetermined extension in a direction perpendicular to a direction of propagation of the light beam. Preferably, the light beams may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

Preferably, the second electrode of the transversal optical sensor may be a split electrode having at least two partial electrodes, wherein the transversal optical sensor has a sensor area, wherein the at least one transversal sensor signal indicates a position of the light beam in the sensor area. Thus, as outlined above, the transversal optical sensor may be or may comprise one or more photo detectors, preferably one or more organic photo detectors, more preferably one or more DSCs or sDSCs. The sensor area may be a surface of the photo detector facing towards the object. The sensor area preferably may be oriented perpendicular to the optical axis. Thus, the transversal sensor signal may indicate a position of a light spot generated by the light beam in a plane of the sensor area of the transversal optical sensor.

Generally, as used herein, the term partial electrode refers to an electrode out of a plurality of electrodes, adapted for measuring at least one current and/or voltage signal, preferably independent from other partial electrodes. Thus, in case a plurality of partial electrodes is provided, the second electrode is adapted to provide a plurality of electric potentials and/or electric currents and/or voltages via the at least two partial electrodes, which may be measured and/or used independently.

When using at least one transversal optical sensor having at least one split electrode having two or more partial electrodes as a second electrode, currents through the partial electrodes may be dependent on a position of the light beam in the sensor area. This may generally be due to the fact that Ohmic losses or resistive losses may occur on the way from a location of generation of electrical charges due to the impinging light to the partial electrodes. Thus, besides the partial electrodes, the second electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed e.g. in U.S. Pat. No. 6,995,445 and/or US 2007/0176165 A1.

The transversal optical sensor may further be adapted to generate the transversal sensor signal in accordance with the electrical currents through the partial electrodes. Thus, a ratio of electric currents through two horizontal partial electrodes may be formed, thereby generating an x-coordinate, and/or a ratio of electric currents through to vertical partial electrodes may be formed, thereby generating a y-coordinate. The detector, preferably the transversal optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes generally may be defined in various ways, in order to determine a position of the light beam in the sensor area. Thus, two or more horizontal partial electrodes may be provided in order to determine a horizontal coordinate or x-coordinate, and two or more vertical partial electrodes may be provided in order to determine a vertical coordinate or y-coordinate. Thus, the partial electrodes may be provided at a rim of the sensor area, wherein an interior space of the sensor area remains free and may be covered by one or more additional electrode materials. As will be outlined in further detail below, the additional electrode material preferably may be a transparent additional electrode material, such as a transparent metal and/or a transparent conductive oxide and/or, most preferably, a transparent conductive polymer.

Further preferred embodiments may refer to the photovoltaic material. Thus, the photovoltaic material of the transversal optical sensor may comprise at least one organic photovoltaic material. Thus, generally, the transversal optical sensor may be an organic photo detector. Preferably, the organic photo detector may be a dye-sensitized solar cell. The dye-sensitized solar cell preferably may be a solid dye-sensitized solar cell, comprising a layer setup embedded in between the first electrode and the second electrode, the layer setup comprising at least one n-semiconducting metal oxide, at least one dye, and at least one solid p-semiconducting organic material. Further details and optional embodiments of the dye-sensitized solar cell (DSC) will be disclosed below.

The at least one first electrode of the transversal optical sensor preferably is transparent. As used in the present invention, the term transparent generally refers to the fact that the intensity of light after transmission through the transparent object equals to or exceeds 10%, preferably 40% and, more preferably, 60% of the intensity of light before transmission through the transparent object. More preferably, the at least one first electrode of the transversal optical sensor may fully or partially be made of at least one transparent conductive oxide (TOO). As an example, indium-doped tin oxide (ITO) and/or fluorine-doped tin oxide (FTO) may be named. Further examples will be given below.

Further, the at least one second electrode of the transversal optical sensor preferably may fully or partially be transparent. Thus, specifically, the at least one second electrode may comprise two or more partial electrodes and at least one additional electrode material contacting the two or more partial electrodes. The two or more partial electrodes may be intransparent. As an example, the two or more partial electrodes may fully or partially be made of a metal. Thus, the two or more partial electrodes preferably are located at a rim of the sensor area. The two or more partial electrodes, however, may electrically be connected by the at least one additional electrode material which, preferably, is transparent. Thus, the second electrode may comprise an intransparent rim having the two or more partial electrodes and a transparent inner area having the at least one transparent additional electrode material. More preferably, the at least one second electrode of the transversal optical sensor, such as the above-mentioned at least one additional electrode material, may fully or partially be made of at least one conductive polymer, preferably a transparent conductive polymer. As an example, conductive polymers having an electrical conductivity of at least 0.01 S/cm may be used, preferably of at least 0.1 S/cm or, more preferably, of at least 1 S/cm or even at least 10 S/cm or at least 100 S/cm. As an example, the at least one conductive polymer may be selected from the group consisting of: a poly-3,4-ethylenedioxythiophene (PEDOT), preferably PEDOT being electrically doped with at least one counter ion, more preferably PEDOT doped with sodium polystyrene sulfonate (PEDOT:PSS); a polyaniline (PANI); a polythiophene.

As outlined above, the conductive polymer may provide an electrical connection between the at least two partial electrodes. The conductive polymer may provide an Ohmic resistivity, allowing for determining the position of charge generation. Preferably, the conductive polymer provides an electric resistivity of 0.1-20 kΩ between the partial electrodes, preferably an electric resistivity of 0.5-5.0 kΩ and, more preferably, an electric resistivity of 1.0-3.0 kΩ. As an example, one or more conductive polymer films having a surface conductivity of at least 0.00001 S/cm, at least 0.001 S/cm or at least 0.01 S/cm may be used, preferably of at least 0.1 S/cm or, more preferably, of at least 1 S/cm or even at least 10 S/cm or at least 100 S/cm.

Generally, as used herein, a conductive material may be a material which has a specific electrical resistance of less than 104, less than 103, less than 102, or of less than 10 Ωm. Preferably, the conductive material has a specific electrical resistance of less than 10-1, less than 10-2, less than 10-3, less than 10-5, or less than 10-6 Ωm. Most preferably, the specific electrical resistance of the conductive material is less than 5×10-7 Ωm or is less than 1×10-7 Ωm, particularly in the range of the specific electrical resistance of aluminum.

As outlined above, preferably, at least one of the optional at least one transversal optical sensor and the optional at least one longitudinal optical sensor is a transparent optical sensor. Thus, the at least one transversal optical sensor may be a transparent transversal optical sensor and/or may comprise at least one transparent transversal optical sensor. Additionally or alternatively, the at least one longitudinal optical sensor may be a transparent longitudinal optical sensor and/or may comprise at least one transparent longitudinal optical sensor. In case a plurality of longitudinal optical sensors is provided, such as a stack of longitudinal optical sensors, preferably all longitudinal optical sensors of the plurality and/or the stack or all longitudinal optical sensors of the plurality and/or the stack but one longitudinal optical sensor are transparent. As an example, in case a stack of longitudinal optical sensors is provided, wherein the longitudinal optical sensors are arranged along the optical axis of the detector, preferably all longitudinal optical sensors but the last longitudinal optical sensor facing away from the object may be transparent longitudinal optical sensors. The last longitudinal optical sensor, i.e. the longitudinal optical sensor on the side of the stack facing away from the object, may be a transparent longitudinal optical sensor or an intransparent longitudinal optical sensor. Exemplary embodiments will be given below.

In case one of the transversal optical sensor and the longitudinal optical sensor is a transparent optical sensor or comprises at least one transparent optical sensor, the light beam may pass through the transparent optical sensor before impinging on the other one of the transversal optical sensor and the longitudinal optical sensor. Thus, the at least one light beam reflected by the target device traveling towards the detector may subsequently reach the transversal optical sensor and the longitudinal optical sensor or vice versa.

Further embodiments refer to the relationship between the transversal optical sensor and the longitudinal optical sensor. Thus, in principle, the transversal optical sensor and the longitudinal optical sensor at least partially may be identical, as outlined above. Preferably, however, the transversal optical sensor and the longitudinal optical sensor at least partially may be independent optical sensors, such as independent photo detectors and, more preferably, independent DSCs or sDSCs.

As outlined above, the transversal optical sensor and the longitudinal optical sensor preferably may be stacked along the optical axis. Thus, the light beam reflected by the target device traveling towards the detector, travelling along the optical axis, may both impinge on the transversal optical sensor and on the longitudinal optical sensor, preferably subsequently. Thus, the light beam may subsequently pass through the transversal optical sensor and the longitudinal optical sensor or vice versa.

As outlined above, the at least one longitudinal sensor signal, given the same total power of the illumination by the light beam, may be dependent on a beam cross-section of the respective light beam in the sensor region of the at least one longitudinal optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light spots are generated, the cross-section may be determined in any other feasible way, such as by determining the cross-section of a circle having the same area as the non-circular light spot, which is also referred to as the equivalent beam cross-section.

Thus, given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, an item of information or at least one item of information on the beam cross-section, specifically on the beam diameter, may be generated. For details of this effect, reference may be made to one or more of WO 2012/110924 A1, U.S. 61/739,173 and 61/749,964. Specifically in case one or more beam properties of the light beams propagating from the target devices to the detector are known, the longitudinal coordinates of the target devices may thus be derived from a known relationship between the at least one longitudinal sensor signal and a longitudinal position of the target device. The known relationship may be stored in the evaluation device as an algorithm and/or as one or more calibration curves. As an example, specifically for Gaussian beams, a relationship between a beam diameter or beam waist and the respective longitudinal coordinate of the target device from which the respective light beam propagates towards the detector may easily be derived by using the Gaussian relationship between the beam waist and a longitudinal coordinate.

The above-mentioned effect, which is also referred to as the FiP-effect (alluding to the effect that the beam cross section φ influences the electric power P generated by the longitudinal optical sensor), may depend on or may be emphasized by an appropriate modulation of the light beam, as disclosed in one or more of WO 2012/110924 A1, U.S. 61/739,173 and 61/749,964. Thus, preferably, the detector device may furthermore have at least one modulation device for modulating the light beams or one or more of the light beams. The modulation device may fully or partially be implemented into at least one illumination source and/or into at least one of the illumination sources and/or may fully or partially be designed as a separate modulation device.

The detector may be designed to detect at least two longitudinal sensor signals in the case of different modulations, in particular at least two sensor signals at respectively different modulation frequencies. In this case, the evaluation device may be designed to generate the at least one item of information on the longitudinal position of the object by evaluating the at least two longitudinal sensor signals.

Generally, the longitudinal optical sensor may be designed in such a way that the at least one longitudinal sensor signal, given the same total power of the illumination, is dependent on a modulation frequency of a modulation of the illumination. Further details and exemplary embodiments will be given below. This property of frequency dependency is specifically provided in DSCs and, more preferably, in sDSCs. However, other types of optical sensors, preferably photo detectors and, more preferably, organic photo detectors may exhibit this effect.

Preferably, the transversal optical sensor and the longitudinal optical sensor both are thin film devices, having a layer setup of layer including electrode and photovoltaic material, the layer setup having a thickness of preferably no more than 1 mm, more preferably of at most 500 μm or even less. Thus, the sensor region of the transversal optical sensor and/or the sensor region of the longitudinal optical sensor preferably each may be or may comprise a sensor area, which may be formed by a surface of the respective device facing towards the object.

Preferably, the sensor region of the transversal optical sensor and/or the sensor region of the longitudinal optical sensor may be formed by one continuous sensor region, such as one continuous sensor area or sensor surface per device. Thus, preferably, the sensor region of the longitudinal optical sensor or, in case a plurality of longitudinal optical sensors is provided (such as a stack of longitudinal optical sensors), each sensor region off the longitudinal optical sensor, may be formed by exactly one continuous sensor region. The longitudinal sensor signal preferably is a uniform sensor signal for the entire sensor region of the longitudinal optical sensor or, in case a plurality of longitudinal optical sensors is provided, is a uniform sensor signal for each sensor region of each longitudinal optical sensor.

The at least one transversal optical sensor and/or the at least one longitudinal optical sensor each, independently, may have a sensor region providing a sensitive area, also referred to as a sensor area, of at least 1 mm², preferably of at least 5 mm², such as a sensor area of 5 mm² to 1000 cm², preferably a sensor area of 7 mm² to 100 cm², more preferably a sensor area of 1 cm². The sensor area preferably has a rectangular geometry, such as a square geometry. However, other geometries and/or sensor areas are feasible.

The longitudinal sensor signal preferably may be selected from the group consisting of a current (such as a photocurrent) and a voltage (such as a photovoltage). Similarly, the transversal sensor signal preferably may be selected from the group consisting of a current (such as a photocurrent) and a voltage (such as a photovoltage) or any signal derived thereof, such as a quotient of currents and/or voltages. Further, the longitudinal sensor signal and/or the transversal sensor signal may be preprocessed, in order to derive refined sensor signals from raw sensor signals, such as by averaging and/or filtering.

Generally, the longitudinal optical sensor may comprise at least one semiconductor detector, in particular an organic semiconductor detector comprising at least one organic material, preferably an organic solar cell and particularly preferably a dye solar cell or dye-sensitized solar cell, in particular a solid dye solar cell or a solid dye-sensitized solar cell. Preferably, the longitudinal optical sensor is or comprises a DSC or sDSC. Thus, preferably, the longitudinal optical sensor comprises at least one first electrode, at least one n-semiconducting metal oxide, at least one dye, at least one p-semiconducting organic material, preferably a solid p-semiconducting organic material, and at least one second electrode. In a preferred embodiment, the longitudinal optical sensor comprises at least one DSC or, more preferably, at least one sDSC. As outlined above, preferably, the at least one longitudinal optical sensor is a transparent longitudinal optical sensor or comprises at least one transparent longitudinal optical sensor. Thus, preferably, both the first electrode and the second electrode are transparent or, in case a plurality of longitudinal optical sensors is provided, at least one of the longitudinal optical sensors is designed such that both the first electrode and the second electrode are transparent. As outlined above, in case a stack of longitudinal optical sensors is provided, preferably all longitudinal optical sensors of the spec are transparent but the last longitudinal optical sensor of the stack furthest away from the object. The last longitudinal optical sensor may be transparent or intransparent. In the latter case, the last longitudinal optical sensor may be designed such that its electrode facing towards the object is transparent, whereas its electrode facing away from the object may be intransparent.

As outlined above, the detector preferably has a plurality of longitudinal optical sensors. More preferably, the plurality of longitudinal optical sensors is stacked, such as along the optical axis of the detector. Thus, the longitudinal optical sensors may form a longitudinal optical sensor stack. The longitudinal optical sensor stack preferably may be oriented such that the sensor regions of the longitudinal optical sensors are oriented perpendicular to the optical axis. Thus, as an example, sensor areas or sensor surfaces of the single longitudinal optical sensors may be oriented in parallel, wherein slight angular tolerances might be tolerable, such as angular tolerances of no more than 10°, preferably of no more than 5°.

In case stacked longitudinal optical sensors are provided, the at least one transversal optical sensor preferably fully or partially is located on a side of the stacked longitudinal optical sensors facing the object. However, other embodiments are feasible. Thus, embodiments are feasible in which the at least one transversal optical sensor is fully or partially located on a side of the transversal optical sensor stack facing away from the object. Again, additionally or alternatively, embodiments are feasible in which the at least one transversal optical sensor is located fully or partially in between the longitudinal optical sensor stack.

The longitudinal optical sensors preferably are arranged such that each light beam from one of the target devices illuminates all longitudinal optical sensors, preferably sequentially. Specifically in this case, preferably, at least one longitudinal sensor signal is generated by each longitudinal optical sensor. This embodiment is specifically preferred since the stacked setup of the longitudinal optical sensors allows for an easy and efficient normalization of the signals, even if an overall power or intensity of the light beam is unknown. Thus, the single longitudinal sensor signals may be known to be generated by one and the same light beam. Thus, the evaluation device may be adapted to normalize the longitudinal sensor signals and to generate the information on the longitudinal position of the object independent from an intensity of the light beam. For this purpose, use may be made of the fact that, in case the single longitudinal sensor signals are generated by one and the same light beam, differences in the single longitudinal sensor signals are only due to differences in the cross-sections of the light beam at the location of the respective sensor regions of the single longitudinal optical sensors. Thus, by comparing the single longitudinal sensor signals, information on a beam cross-section may be generated even if the overall power of the light beam is unknown. From the beam cross-section, information regarding the longitudinal position of the respective target device and, thus, on the longitudinal coordinate of target device, may be gained, specifically by making use of a known relationship between the cross-section of the light beam and the longitudinal position of the target device.

Further, the above-mentioned stacking of the longitudinal optical sensors and the generation of a plurality of longitudinal sensor signals by these stacked longitudinal optical sensors may be used by the evaluation device in order to resolve an ambiguity in a known relationship between a beam cross-section of the light beam and the longitudinal coordinate of the target device. Thus, even if the beam properties of the light beam propagating from the target device to the detector are known fully or partially, it is known that, in many beams, the beam cross-section narrows before reaching a focal point and, afterwards, widens again. Thus, before and often as a focal point in which the light beam has the narrowest beam cross-section, positions along the axis of propagation of the light beam occur in which the light beam has the same cross-section. Thus, as an example, at a distance z0 before and after the focal point, the cross-section of the light beam is identical. Thus, in case only one longitudinal optical sensor is used, a specific cross-section of the light beam might be determined, in case the overall power or intensity of the light beam is known. By using this information, the distance z0 of the respective longitudinal optical sensor from the focal point might be determined. However, in order to determine whether the respective longitudinal optical sensor is located before or behind the focal point, additional information may be required, such as a history of movement of the object and/or the detector and/or information on whether the detector is located before or behind the focal point. In typical situations, this additional information may not be available. Therefore, by using a plurality of longitudinal optical sensors, additional information may be gained in order to resolve the above-mentioned ambiguity. Thus, in case the evaluation device, by evaluating the longitudinal sensor signals, recognizes that the beam cross-section of the light beam on a first longitudinal optical sensor is larger than the beam cross-section of the light beam on a second longitudinal optical sensor, wherein the second longitudinal optical sensor is located behind the first longitudinal optical sensor, the evaluation device may determine that the light beam is still narrowing and that the location of the first longitudinal optical sensor is situated before the focal point of the light beam. Contrarily, in case the beam cross-section of the light beam on the first longitudinal optical sensor is smaller than the beam cross-section of the light beam on the second longitudinal optical sensor, the evaluation device may determine that the light beam is widening and that the location of the second longitudinal optical sensor is situated behind the focal point. Thus, generally, the evaluation device may be adapted to recognize whether the light beam widens or narrows, by comparing the longitudinal sensor signals of different longitudinal sensors.

The longitudinal optical sensor stack preferably may comprise at least three longitudinal optical sensors, more preferably at least four longitudinal optical sensors, even more preferably at least five longitudinal optical sensors or even at least six longitudinal optical sensors. By tracking the longitudinal sensor signals of the longitudinal optical sensors, even a beam profile of the light beam might be evaluated.

As used herein and as used in the following, the diameter of the light beam or, equivalently, a beam waist of the light beam might be used to characterize the beam cross-section of the light beam at a specific location. As outlined above, a known relationship might be used between the longitudinal position of the respective target device, i.e. the target device emitting and/or reflecting the light beam, and the beam cross-section in order to determine the longitudinal coordinate of the target device by evaluating the at least one longitudinal sensor signal. As an example, as outlined above, a Gaussian relationship might be used, assuming that the light beam propagates at least approximately in a Gaussian manner. For this purpose, the light beam might be shaped appropriately, such as by using an illumination source generating a light beam having known propagation properties, such as a known Gaussian profile. For this purpose, the illumination source itself may generate the light beam having the known properties, which, for example, is the case for many types of lasers, as the skilled person knows. Additionally or alternatively, the illumination source and/or the detector may have one or more beam-shaping elements, such as one or more lenses and/or one or more diaphragms, in order to provide a light beam having known properties, as the skilled person will recognize. Thus, as an example, one or more transfer elements may be provided, such as one or more transfer elements having known beam-shaping properties. Additionally or alternatively, the illumination source and/or the detector, such as the at least one optional transfer element, may have one or more wavelength-selective elements, such as one or more filters, such as one or more filter elements for filtering out wavelengths outside an excitation maximum of the at least one transversal optical sensor and/or the at least one longitudinal optical sensor.

Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

As outlined above, the present invention further relates to a human-machine interface for exchanging at least one item of information between a user and a machine. The human-machine interface as proposed may make use of the fact that the above-mentioned detector device in one or more of the embodiments mentioned above or as mentioned in further detail below may be used by one or more users for providing information and/or commands to a machine. Thus, preferably, the human-machine interface may be used for inputting control commands.

The human-machine interface is designed to generate at least one item of geometrical information of the user by means of the detector device. Thus, the geometrical information of the user may imply at least one item of information referring to at least one position and/or at least one orientation of the user or at least one body part of the user. Generally, as used herein, the at least one orientation of the user may imply one or more items of information on an orientation of the user as a whole and/or one of or more body parts of the user. Thus, preferably, the orientation of the user may imply one or more items of information on an orientation of the user as provided by the evaluation device of the detector. The user, a body part of the user or a plurality of body parts of the user may be regarded as one or more objects the orientation of which may be detected by the at least one detector device. Thus, the at least one target device, preferably the two or more target devices, may be attached to the user or held by the user. Additionally or alternatively, the user may hold or manipulate one or more control devices having the one or more target devices attached thereto and/or integrated therein, wherein the position of the control device (including the orientation of the control device) may be detected by the detector and may be transformed into machine commands and/or machine information.

Therein, precisely one detector may be provided, or a combination of a plurality of detectors may be provided. As an example, a plurality of detectors may be provided for determining orientations of a plurality of body parts of the user and/or for determining an orientation of at least one body part of the user.

The human-machine interface may comprise a plurality of target devices which may be adapted to be at least one of directly or indirectly attached to the user and held by the user. The target devices may have different color conversion elements. The target devices each may independently be attached to the user by any suitable means, such as by an appropriate fixing device. Additionally or alternatively, the user may hold and/or carry the at least one target device or one or more of the target devices such as in his or her hands and/or by wearing the at least one target device and/or a garment containing the target device on a body part.

As used herein, a target device generally is an arbitrary device which may be optically detected by the at least one detector and/or which facilitates optical detection by the at least one detector. The at least one target device may permanently or temporarily be attached to the user in a direct or indirect way and/or may be carried or held by the user. The attachment may take place by using one or more attachment means and/or by the user himself or herself, such as by the user holding the at least one target device by hand and/or by the user wearing the target device.

Additionally or alternatively, the target devices may be at least one of attached to an object and integrated into an object held by the user, which, in the sense of the present invention, shall be included into the meaning of the option of the user holding the target devices. Thus, as will be outlined in further detail below, the target devices may be attached to or integrated into a control element which may be part of the human-machine interface and which may be held or carried by the user, and the position (including possibly the orientation) of which may be recognized by the detector device. Thus, generally, the present invention also refers to a detector system comprising at least one detector device according to the present invention and, further, comprising at least one object, wherein the target devices are one of attached to the object, held by the object and integrated into the object. As outlined above, the object preferably may form a control element, the position of which may be influenced by a user. Thus, the detector system may be part of the human-machine interface as outlined above or as outlined in further detail below. As an example, the user may handle the control element in a specific way in order to transmit one or more items of information to a machine, such as in order to transmit one or more commands to the machine.

Alternatively, the detector system may be used in other ways. Thus, as an example, the object of the detector system may be different from a user or a body part of the user and, as an example, may be an object which moves independently from the user. As an example, the detector system may be used for controlling apparatuses and/or industrial processes, such as manufacturing processes and/or robotics processes. Thus, as an example, the object may be a machine and/or a machine part, such as a robot arm, the orientation of which may be detected by using the detector system.

The human-machine interface may be adapted such that the detector device generates at least one item of information on the position of the user or of at least one body part of the user.

The object, which may form part of the detector system, may generally have an arbitrary shape. Preferably, the object being part of the detector system, as outlined above, may be a control element which may be handled by a user, such as manually. As an example, the control element may be or may comprise at least one element selected from the group consisting of: a glove, a jacket, a hat, shoes, trousers and a suit; a stick that may be held by hand; a bat; a club; a racket; a cane; a toy, such as a toy gun. Thus, as an example, the detector system may be part of the human-machine interface and/or of the entertainment device.

As used herein, an entertainment device is a device which may serve the purpose of leisure and/or entertainment of one or more users, in the following also referred to as one or more players. As an example, the entertainment device may serve the purpose of gaming, preferably computer gaming. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

The at least one item of information preferably may comprise at least one command adapted for influencing the course of a game. Thus, as an example, the at least one item of information may include at least one item of information on at least one orientation of the player and/or of one or more body parts of the player, thereby allowing for the player to simulate a specific position and/or orientation and/or action required for gaming. As an example, one or more of the following movements may be simulated and communicated to a controller and/or a computer of the entertainment device: dancing; running; jumping; swinging of a racket; swinging of a bat; swinging of a club; pointing of an object towards another object, such as pointing of a toy gun towards a target; grabbing at least one object by hand; moving at least one object by hand.

The entertainment device as a part or as a whole, preferably a controller and/or a computer of the entertainment device, is designed to vary the entertainment function in accordance with the information. Thus, as outlined above, a course of a game might be influenced in accordance with the at least one item of information. Thus, the entertainment device might include one or more controllers which might be separate from the evaluation device of the at least one detector and/or which might be fully or partially identical to the at least one evaluation device or which might even include the at least one evaluation device. Preferably, the at least one controller might include one or more data processing devices, such as one or more computers and/or microcontrollers.

As further used herein, a tracking system is a device which is adapted to gather information on a series of past orientations of the at least one object and/or at least one part of the object. Additionally, the tracking system may be adapted to provide information on at least one predicted future position and/or orientation of the at least one object or the at least one part of the object. The tracking system may have at least one track controller, which may fully or partially be embodied as an electronic device, preferably as at least one data processing device, more preferably as at least one computer or microcontroller. Again, the at least one track controller may fully or partially comprise the at least one evaluation device and/or may be part of the at least one evaluation device and/or may fully or partially be identical to the at least one evaluation device.

The tracking system comprises at least one detector device according to the present invention, such as at least one detector device as disclosed in one or more of the embodiments listed above and/or as disclosed in one or more of the embodiments below. The tracking system further comprises at least one track controller. The track controller is adapted to track a series of orientations of the object at specific points in time, such as by recording groups of data or data pairs, each group of data or data pair comprising at least one orientation information and at least one time information.

Besides the at least one detector and the at least one evaluation device and the at least one target device, the tracking system may further comprise the object itself or a part of the object, such as at least one control element comprising the target devices or at least one target device, wherein the control element is directly or indirectly attachable to or integratable into the object to be tracked.

The tracking system may be adapted to initiate one or more actions of the tracking system itself and/or of one or more separate devices. For the latter purpose, the tracking system, preferably the track controller, may have one or more wireless and/or wire-bound interfaces and/or other types of control connections for initiating at least one action. Preferably, the at least one track controller may be adapted to initiate at least one action in accordance with at least one actual position of the object. As an example, the action may be selected from the group consisting of: a prediction of a future position of the object; pointing at least one device towards the object; pointing at least one device towards the detector; illuminating the object; illuminating the detector.

As an example of application of a tracking system, the tracking system may be used for continuously pointing at least one first object to at least one second object even though the first object and/or the second object might move. Potential examples, again, may be found in industrial applications, such as in robotics and/or for continuously working on an article even though the article is moving, such as during manufacturing in a manufacturing line or assembly line. Additionally or alternatively, the tracking system might be used for illumination purposes, such as for continuously illuminating the object by continuously pointing an illumination source to the object even though the object might be moving. Further applications might be found in communication systems, such as in order to continuously transmit information to a moving object by pointing a transmitter towards the moving object.

As outlined above, in a further aspect of the present invention, the invention refers to a method for optically detecting at least one position of at least one object. The method preferably may make use of the at least one detector device according to the present invention, such as of at least one detector device according to one or more of the embodiments disclosed above or disclosed in further detail below. Thus, for optional embodiments of the method, reference might be made to the embodiments of the detector device.

As outlined above, preferably, for potential details of the setups of the at least one detector, preferably with regard to the potential setup of one or more of the at least one optional transversal optical detector, the at least one optional longitudinal optical detector, the at least one optional transfer device and the evaluation device, reference may be made to one or more of WO 2012/110924 A1, U.S. 61/739,173 and 61/749,964, specifically with regard to potential electrode materials, organic materials, inorganic materials, layer setups and further details.

The detector may comprise one or more optional transfer devices. The at least one optional transfer device can for example comprise one or a plurality of mirrors and/or beam splitters and/or beam deflecting elements in order to influence a direction of the electromagnetic radiation. Alternatively or additionally, the transfer device can comprise one or a plurality of imaging elements which can have the effect of a converging lens and/or a diverging lens. By way of example, the optional transfer device can have one or a plurality of lenses and/or one or a plurality of convex and/or concave mirrors. Once again alternatively or additionally, the transfer device can have at least one wavelength-selective element, for example at least one optical filter. Once again alternatively or additionally, the transfer device can be designed to impress a predefined beam profile on the electromagnetic radiation, for example, at the location of the sensor region and in particular the sensor area. The above mentioned optional embodiments of the optional transfer device can, in principle, be realized individually or in any desired combination.

Further, generally, it shall be noted that, in the context of the present invention, an optical sensor may refer to an arbitrary element which is designed to convert at least one optical signal into a different signal form, preferably into at least one electrical signal, for example a voltage signal and/or a current signal. In particular the optical sensor can comprise at least one optical-electrical converter element, preferably at least one photodiode and/or at least one solar cell. As is explained in even greater detail below, in the context of the present invention, preference is attached particularly to a use of at least one organic optical sensor, that is to say an optical sensor which comprises at least one organic material, for example at least one organic semiconductor material.

In the context of the present invention, a sensor region should be understood to mean a two-dimensional or three-dimensional region which preferably, but not necessarily, is continuous and can form a continuous region, wherein the sensor region is designed to vary at least one measurable property, in a manner dependent on the illumination. By way of example, said at least one property can comprise an electrical property, for example, by the sensor region being designed to generate, solely or in interaction with other elements of the optical sensor, a photovoltage and/or a photocurrent and/or some other type of signal. In particular, the sensor region can be embodied in such a way that it generates a uniform, preferably a single, signal in a manner dependent on the illumination of the sensor region. The sensor region can thus be the smallest unit of the optical sensor for which a uniform signal, for example, an electrical signal, is generated, which preferably can no longer be subdivided to partial signals, for example for partial regions of the sensor region. The transversal optical sensor and/or the longitudinal optical sensor each can have one or else a plurality of such sensor regions, the latter case for example by a plurality of such sensor regions being arranged in a two-dimensional and/or three-dimensional matrix arrangement.

The at least one sensor region can comprise for example at least one sensor area, that is to say a sensor region whose lateral extent considerably exceeds the thickness of the sensor region, for example by at least a factor of 10, preferably by at least a factor of 100 and particularly preferably by at least a factor of 1000. Examples of such sensor areas can be found in organic or inorganic photovoltaic elements, for example, in accordance with the prior art described above, or else in accordance with the exemplary embodiments described in even greater detail below. The detector can have one or a plurality of such optical sensors and/or sensor regions. By way of example, a plurality of optical sensors can be arranged linearly in a spaced-apart manner or in a two-dimensional arrangement or else in a three-dimensional arrangement, for example by a stack of photovoltaic elements being used, preferably organic photovoltaic elements, preferably a stack in which the sensor areas of the photovoltaic elements are arranged parallel to one another. Other embodiments are also possible.

The optional transfer device can, as explained above, be designed to feed light propagating from the object to the detector to the transversal optical sensor and/or the longitudinal optical sensor, preferably successively. As explained above, this feeding can optionally be effected by means of imaging or else by means of non-imaging properties of the transfer device. In particular the transfer device can also be designed to collect the electromagnetic radiation before the latter is fed to the transversal and/or longitudinal optical sensor. The optional transfer device can also, as explained in even greater detail below, be wholly or partly a constituent part of at least one optional illumination source, for example by the illumination source being designed to provide a light beam having defined optical properties, for example having a defined or precisely known beam profile, for example at least one Gaussian beam, in particular at least one laser beam having a known beam profile.

For potential embodiments of the optional illumination source, reference may be made to WO 2012/110924 A1. Still, other embodiments are feasible. The illumination source can for example be or comprise an ambient illumination source and/or may be or may comprise an artificial illumination source. By way of example, the detector itself can comprise at least one illumination source, for example at least one laser and/or at least one incandescent lamp and/or at least one semiconductor illumination source, for example, at least one light-emitting diode, in particular an organic and/or inorganic light-emitting diode. On account of their generally defined beam profiles and other properties of handleability, the use of one or a plurality of lasers as illumination source or as part thereof, is particularly preferred. The illumination source itself can be a constituent part of the detector or else be formed independently of the detector. The illumination source can be integrated in particular into the detector, for example a housing of the detector. Alternatively or additionally, at least one illumination source can also be integrated into the at least one target device and/or into the object or connected or spatially coupled to the object.

The feeding of the light to the detector, specifically to the at least one transversal and/or the at least one longitudinal optical sensor, can be effected in particular in such a way that a light spot, for example having a round, oval or differently configured cross section, is produced on the optional sensor area of the transversal and/or longitudinal optical sensor. By way of example, the detector can have a visual range, in particular a solid angle range and/or spatial range, within which objects can be detected. Preferably, the optional transfer device is designed in such a way that the light spot, for example in the case of an object arranged within a visual range of the detector, is arranged completely on the sensor region, in particular the sensor area. By way of example, a sensor area can be chosen to have a corresponding size in order to ensure this condition.

The at least one longitudinal optical sensor, as outlined above, can be designed for example in such a way that the longitudinal sensor signal, given the same power of the illumination, that is to say for example given the same integral over the intensity of the illumination on the sensor area, is dependent on the geometry of the illumination, that is to say for example on the diameter and/or the equivalent diameter for the sensor spot. By way of example, the longitudinal optical sensor can be designed in such a way that upon a doubling of the beam cross section given the same total power, a signal variation occurs by at least a factor of 3, preferably by at least a factor of 4, in particular a factor of 5 or even a factor of 10. This condition can hold true for example for a specific focusing range, for example for at least one specific beam cross section. Thus, by way of example, the longitudinal sensor signal can have, between at least one optimum focusing at which the signal can have for example at least one global or local maximum and a focusing outside said at least one optimum focusing, a signal difference by at least a factor of 3, preferably by at least a factor of 4, in particular a factor of 5 or even a factor of 10. In particular, the longitudinal sensor signal can have as a function of the geometry of the illumination, for example of the diameter or equivalent diameter of a light spot, at least one pronounced maximum, for example with a boost by at least a factor of 3, particularly preferably by at least a factor of 4 and particularly preferably by at least a factor of 10. Consequently, the longitudinal optical sensor may be based on the above-mentioned FiP-effect, which is disclosed in great detail in WO 2012/110924 A1. Thus, specifically in sDSCs, the focusing of the light beam may play a decisive role, i.e. the cross-section or cross-sectional area on which a certain number or rate of photons (nph) is incident. The more tightly the light beam is focused, i.e. the smaller its cross-section, the higher the photo current may be. The term ‘FiP’ expresses the relationship between the cross-section φ (Fi) of the incident beam and the solar cell's power (P).

The at least one longitudinal optical sensor may be combined with at least one transversal optical sensor in order to preferably provide appropriate position information of the object.

Such effects of the dependence of the at least one longitudinal sensor signal on a beam geometry, preferably a beam cross-section of the at least one light beam, were observed in the context of the investigations leading to the present invention in particular in the case of organic photovoltaic components, that is to say photovoltaic components, for example, solar cells, which comprise at least one organic material, for example at least one organic p semiconducting material and/or at least one organic dye. By way of example, such effects, as is explained in even greater detail below by way of example, were observed in the case of dye solar cells, that is to say components which have at least one first electrode, at least one n-semiconducting metal oxide, at least one dye, at least one p semiconducting organic material, preferably a solid organic p-type semiconductor, and at least one second electrode. Such dye solar cells, preferably solid dye solar cells (solid dye sensitized solar cells, sDSC), are known in principle in numerous variations from the literature.

In particular, the at least one longitudinal optical sensor can be designed in such a way that the sensor signal, given the same total power of the illumination, is substantially independent of a size of the sensor region, in particular of a size of the sensor area, in particular as long as the light spot of the illumination lies completely within the sensor region, in particular the sensor area. Consequently, the longitudinal sensor signal can be dependent exclusively on a focusing of the electromagnetic rays on the sensor area. In particular the sensor signal can be embodied in such a way that a photocurrent and/or a photovoltage per sensor area have/has the same values given the same illumination, for example the same values given the same size of the light spot.

The evaluation device can comprise in particular at least one data processing device, in particular an electronic data processing device. The data processing device specifically can be designed to generate the at least one item of information on the transversal position of the target device by evaluating the at least one transversal sensor signal and to generate the at least one item of information on the longitudinal position of the target device by evaluating the at least one longitudinal sensor signal. Thus, the evaluation device may be designed to use the at least one transversal sensor signal and the at least one longitudinal sensor signal as input variables and to generate the items of information on the transversal position and the longitudinal position of the target device by processing these input variables. Thereby, a position of the at least one target device being one or more of attached to the object, integrated into the object or held by the object may be calculated by the evaluation device. In case a plurality of the target devices is provided, the position of each of the target devices may be calculated.

The processing can be done in parallel, subsequently or even in a combined manner. The evaluation device may use an arbitrary process for generating these items of information, such as by calculation and/or using at least one stored and/or known relationship. Besides the at least one transversal sensor signal and at least one longitudinal sensor signal, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One calibration curve or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the at least one transversal sensor signal into the at least one item of information on the transversal position and for processing the at least one longitudinal sensor signal into the at least one item of information on the longitudinal position may be used. Alternatively, at least one combined relationship for processing the sensor signals is feasible. Various possibilities are conceivable and can also be combined.

By way of example, the evaluation device can be designed in terms of programming for the purpose of calculating the at least one position of the at least one target device, such as for determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

As outlined above, the total intensity of total power of the light beams is often unknown, since this total power e.g. may depend on the properties of the target devices, such as reflecting properties and/or emitting properties, and/or may depend on a total power of an illumination source and/or may depend on a large number of environmental conditions. Since the above-mentioned known relationship between the at least one longitudinal optical sensor signal and a beam cross-section of the light beam in the at least one sensor region of the at least one longitudinal optical sensor and, thus, a known relationship between the at least one longitudinal optical sensor signal and the at least one item of information on the orientation of the object may depend on the total power of total intensity of the light beam, various ways of overcoming this uncertainty are feasible. Thus, as outlined in great detail in WO 2012/110924 A1, a plurality of longitudinal sensor signals may be detected by the same longitudinal optical sensor, such as by using different modulation frequencies of an illumination of the object. Thus, at least two longitudinal sensor signals may be acquired at different frequencies of a modulation of the illumination, wherein, from the at least two sensor signals, for example by comparison with corresponding calibration curves, it is possible to deduce the total power and/or the geometry of the illumination, and/or therefrom, directly or indirectly, to deduce the at least one item of information on the orientation of the object.

Additionally or alternatively, however, as outlined above, the detector may comprise a plurality of longitudinal optical sensors, each longitudinal optical sensor being adapted to generate at least one longitudinal sensor signal. The longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the respective target device for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on target device and, thus, into the respective longitudinal coordinate of the respective target device. Other ways of normalization are feasible, such as a normalization using a mean value of the longitudinal sensor signals and dividing all longitudinal sensor signals by the mean value. Other options are possible. Each of these options is suited to render the transformation independent from the total power and/or intensity of the respective light beam. In addition, information on the total power and/or intensity of the respective light beams might be generated.

As outlined above, one of the light beams, more than one of the light beams or even all of the light beams may be modulated, such as by amplitude modulation and/or phase modulation, most preferably by amplitude modulation. As also outlined above, this modulation, preferably the amplitude modulation, may be performed for various purposes. Thus, the FiP-effect itself which may be used for detecting the longitudinal coordinates of the target devices in the coordinate system of the detector may depend on the modulation frequency, as outlined above and as outlined in further detail below. Thus, the modulation may be chosen to increase the FiP effect and, thereby, to increase the accuracy of the determination of the longitudinal coordinates of the target devices.

As outlined above, a plurality of target devices each may be one or more of attached to the object, integrated into the object or held by the object. The target devices may have differing properties, in order to distinguish the light beams reflected by the respective target devices, i.e. in order to allow for the detector to identify the respective target device from which a light beam originates. Thus, specifically, the target devices may have different color conversion elements. Thus, as an example, the light beams being reflected by different target devices may have different colors. The detector may be adapted, such as by using at least one wavelength-sensitive element, specifically at least one color separation element, to distinguish the light beams having different colors and, thus, to identify the respective target device from which the light beam originates. Thus, as an example, a first one of the target devices may reflect a light beam having a color λ1, whereas a second one of the target devices may reflect a light beam having a color λ2≠λ1, and so forth.

The detector may be adapted to generate detector signals for the different light beams having different colors and originating from different target devices sequentially and/or in parallel.

Thus, for generating detector signals for the different colors in parallel, the light entering the detector may be separated according to its color, in order to separate components of the light beam according to their origin, i.e. according to the target device from which it originates. Thus, within the detector, a plurality of partial light paths may be present, each light path corresponding to a specific color. For splitting the light path into the plurality of partial light paths, at least one wavelength-sensitive element may be used, such as one or more of a prism, a grating or a dichroitic mirror. At least one optical sensor may be in each of the partial light paths, in order to generate at least one detector signal for each of the partial light paths.

Additionally or alternatively, for detecting detector signals for the different colors sequentially, the at least one wavelength-sensitive element may be adapted to sequentially influence the light beam and/or sequentially separate the light beam entering the detector. As an example for a sequential process, a rotating filter wheel may be used, having filter segments of different transmission properties. Thus, each cycle of rotation of the filter wheel may be split into time segments, wherein each segment may correspond to a different color. Thus, at least one optical sensor may be placed behind the filter wheel, in order to generate at least one combined detector signal. By evaluating the at least one combined detector signal in a time-resolved fashion, such as by using a phase sensitive detection, the combined detector signal may be split into partial detector signals corresponding to the different time segments and, thus, corresponding to the different colors of the light beam. Thereby, detector signals for each color may be generated, corresponding to the light beams being reflected by the different target devices.

Thus, by assigning the signals of the at least one longitudinal optical sensor to the respective target device by using the color as a distinguishing parameter, the longitudinal coordinates and/or the transversal coordinates of the target devices may be determined independently.

The detector device, such as the detector, can furthermore have at least one modulation device. Generally, a modulation of a light beam should be understood to mean a process in which a total power and/or a phase, most preferably a total power, of the respective light beam is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the target device and the optical sensor, for example by the at least one modulation device being arranged in said beam path. Alternatively or additionally, however, the modulation can also be effected in a beam path between an optional illumination source for illuminating the target device and the object, for example by the at least one modulation device being arranged in said beam path. Again, additionally or alternatively, the modulation can take place within the detector. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various possibilities are conceivable.

By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz, specifically for the purpose of the FiP effect.

For potential embodiments of the above-mentioned elements of the detector, such as the at least one optional longitudinal optical sensor and/or the at least one optional transversal optical sensor, reference may be made to various documents in the literature, for example to one or more of WO 2012/110924 A1, US 2007/0176165 A1, U.S. Pat. No. 6,995,445 B2, DE 2501124 A1, DE 3225372 A1, WO 2009/013282 A1, U.S. 61/739,173 and 61/749,964. Thus, specifically, reference may be made to one or more of WO 2012/110924 A1, U.S. 61/739,173 and 61/749,964, with regard to one or more of the following components which may be implied in the at least one optional longitudinal optical sensor and/or the at least one optional transversal optical sensor: the first electrode and the n-semiconductive metal oxide; the dye; the p-semiconducting organic material; the second electrode, specifically the second electrode of the transversal optical sensor and/or the second electrode of the longitudinal optical sensor; the encapsulation. Still, other embodiments are feasible. Further, with regard to synthesis examples, reference may be made to one or more of the named documents, specifically to one or more of WO 2012/110924 A1, U.S. 61/739,173.

Summarizing the findings of the present invention, the following embodiments are preferred:

### EMBODIMENT 1

A target device for use in optical detection of at least one object, the target device being adapted for at least one of being integrated into the object, being held by the object or being attached to the object, the target device having at least one reflective element for reflecting a light beam, the target device further having at least one color conversion element, the color conversion element being adapted to change at least one spectral property of the light beam during reflecting the light beam.

### EMBODIMENT 2

The target device according to the preceding embodiment, wherein the spectral property is selected from the group consisting of: a color of the light beam; a peak wavelength of a spectrum of the light beam; a polarization of the light beam.

### EMBODIMENT 3

The target device according to any one of the preceding embodiments, wherein the color conversion element is adapted to change a color of the light beam during reflecting the light beam.

### EMBODIMENT 4

The target device according to the preceding embodiment, wherein the color conversion element is one of a down-conversion color conversion element adapted for shifting the color of the light beam towards longer wavelengths and up-conversion color conversion element adapted for shifting the color of the light beam towards lower wavelengths.

### EMBODIMENT 5

The target device according to the preceding embodiment, wherein the color conversion element is a down-conversion color conversion element, wherein the down-conversion color conversion element comprises at least one of: a perylene dye; a naphthalene dye, in particular a naphthalene benzimidazole; a squaraine dye; a diketopyrrolopyrrole dye; an acridine dye; a pyrene dye; triarylamines; rhodamines; fluoresceines; a rare-earth metal complex; a transition metal complex; an inorganic metal oxide pigment; an inorganic absorber; an inorganic pigment; a phthalocyanine dye; a porphyrine dye; an organic pigment; other fluorescent dyes and pigments known to the skilled person.

### EMBODIMENT 6

The target device according to any one of the two preceding embodiments, wherein the color conversion element is an up-conversion color conversion element, wherein the up-conversion color conversion element comprises at least one rare earth metal complex.

### EMBODIMENT 7

The target device according to any one of the preceding embodiments, wherein the color conversion element comprises at least one dye.

### EMBODIMENT 8

The target device according to the preceding embodiment, wherein the dye is selected from the group consisting of an organic dye or pigment and an inorganic dye or pigment.

### EMBODIMENT 9

The target device according to any one of the preceding embodiments, wherein the color conversion element comprises at least one color converter, specifically at least one color converter as disclosed in WO 2012/152812 A1 and/or as disclosed in WO 2012/168395 A1.

### EMBODIMENT 10

The target device according to any one of the preceding embodiments, wherein the target device comprises a layer setup having at least one reflective layer forming the reflective element and at least one color conversion layer forming the color conversion element, the color conversion layer being disposed onto the reflective layer, the color conversion layer comprising the at least one color conversion element.

### EMBODIMENT 11

The target device according to the preceding embodiment, wherein the reflective layer contains one or more reflective elements, preferably one or more reflective elements selected from the group consisting of: angular reflectors; retro-reflectors; Luneburg-lenses; areal retro-reflectors.

### EMBODIMENT 12

The target device according to any one of the preceding embodiments, wherein the reflective element comprises at least one flexible material, preferably a flexible material selected from the group consisting of: a flexible plastic material, a flexible textile, a glass bead tape, a micro-prismatic retro-reflective tape.

### EMBODIMENT 13

The target device according to any one of the preceding embodiments, wherein the target device has a diameter or equivalent diameter of 0.5 mm to 50 mm, preferably of 1.0 mm to 20 mm and more preferably of 5.0 mm to 10 mm.

### EMBODIMENT 14

The target device according to any one of the preceding embodiments, wherein the color conversion element comprises at least one matrix element and at least one color conversion material embedded into the matrix element.

### EMBODIMENT 15

The target device according to the preceding embodiment, wherein the matrix element comprises at least one transparent matrix material.

### EMBODIMENT 16

The target device according to any one of the two preceding embodiments, wherein the matrix element comprises at least one matrix material selected from the group consisting of: a resin; a polymer, preferably a polymer selected from the group consisting of: polyethylene-terephthalate (PET), polystyrene, polyurethane, a synthetic or natural rubber, a polyester, a polycarbonate, a poly-acrylate, a polyamide, a silicone, a thermoplastic polymer, an elastic polymer; glass; silicon dioxide; a salt; an amorphous organic or inorganic phase; a crystalline organic or inorganic phase; a glue such as an epoxy glue.

### EMBODIMENT 17

The target device according to the preceding embodiment, wherein the target device comprises at least one light-scattering material dispersed into the matrix material.

### EMBODIMENT 18

The target device according to the preceding embodiment, wherein the light-scattering material comprises inorganic particles, specifically titanium dioxide.

### EMBODIMENT 19

The target device according to any one of the preceding embodiments, wherein the color conversion element comprises one or more of: an organic color conversion element, more preferably a polymer color conversion element; a color conversion pigment; a color conversion phosphor; a metal-organic color conversion element; an inorganic color conversion pigment.

### EMBODIMENT 20

The target device according to any one of the preceding embodiments, wherein the target device further comprises at least one attachment device adapted for attaching the target device to at least one object.

### EMBODIMENT 21

The target device according to the preceding embodiment, wherein the attachment device comprises at least one element selected from the group consisting of: an adhesive surface; a Velcro fastener; a strap; a hook; a clamp; a magnet; a ribbon; a belt; a button; a zipper; a rubber band; a suction cup; a fastener selected from the group consisting of: a clip, a clamp, a pin, a snap fastener, another kind of fastener known to the skilled person.

### EMBODIMENT 22

A kit comprising a plurality of the target devices according to any one of the preceding embodiments, wherein at least two of the target devices have different color conversion elements.

### EMBODIMENT 23

An object detectable by at least one optical detector, the object comprising at least one target device according to any one of the preceding embodiments referring to a target device, wherein the target device is at least one of integrated into the object, held by the object or attached to the object.

### EMBODIMENT 24

The object according to the preceding embodiment, wherein the object comprises a plurality of the target devices, wherein at least two of the target devices have different color conversion elements.

### EMBODIMENT 25

The object according to the preceding embodiment, wherein the plurality of the target devices comprise at least one first target device and at least one second target device, the first target device having a first color conversion element, wherein the first color conversion element is adapted to change a color of the light beam into a first target color, the second target device having a second color conversion element, wherein the second color conversion element is adapted to change a color of the light beam into a second target color, the second target color being different from the first target color.

### EMBODIMENT 26

The object according to any one of the preceding embodiments referring to an object, wherein the object is selected from the group consisting of: a garment, preferably a garment selected from the group consisting of a hat, a cap, a glove, a suit, a shirt, pants, a pullover, a jacket, a coat or a mask; a sports device, preferably a sports device selected from the group consisting of a racket, a bat; a toy, preferably a toy selected from the group consisting of a toy gun and a toy sword; a control device for controlling a machine, preferably a control device for controlling one or more of: a computer, a television set, another entertainment device, a remote-controlled toy such as a toy car, an airplane or a boat, more preferably a hand-held control device being holdable by a user; a mobile electronics device, preferably a mobile communication device such as a mobile phone, preferably a smart phone; a musical instrument or device for using a musical instrument such as a plectrum, a stick, a drumstick or a fiddlestick or violin bow; a traffic sign; a traffic signal; a car; a bicycle; a motorbike; a forklift, such as a forklift truck; an object equipped with reflective material to ensure visibility due to high safety requirements.

### EMBODIMENT 27

A detector device for detecting at least one object, comprising at least one target device according to any one of the preceding embodiments referring to a target device, the target device being at least one of attached to the object, held by the object or integrated into the object, the detector device further comprising at least one optical detector adapted for detecting at least one light beam reflected by the target device, wherein the detector device is adapted for determining at least one position of the object by determining at least one position of the target device.

### EMBODIMENT 28

The detector device according to the preceding embodiment, furthermore comprising at least one illumination source adapted for illuminating the target device.

### EMBODIMENT 29

The detector device according to any one of the preceding embodiments referring to a detector device, comprising a plurality of the target devices, wherein at least two of the target devices have different color conversion elements.

### EMBODIMENT 30

The detector device according to the preceding embodiment, wherein the at least one first color conversion element of a first target device is adapted to change a color of the light beam into a first color, wherein at least one second color conversion device of a second target device is adapted to change the color of the light beam into a second color, wherein the second color is different from the first color.

### EMBODIMENT 31

The detector device according to the preceding embodiment, wherein the detector device further comprises at least one color-sensitive element, wherein the detector device is adapted to distinguish the target devices by the color of light beams reflected by these target devices.

### EMBODIMENT 32

The detector device according to the preceding embodiment, wherein the color-sensitive element comprises at least one element selected from the group consisting of: a filter, preferably a filter wheel; a prism; a grating; a dichroitic mirror; a color-sensitive detector element.

### EMBODIMENT 33

The detector device according to any one of the preceding embodiments referring to a detector device, wherein the optical detector comprises at least one longitudinal optical sensor, wherein the longitudinal optical sensor has at least one sensor region, wherein the longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein the optical detector further comprises at least one evaluation device, wherein the evaluation device is designed to generate at least one item of information on a longitudinal position of the object by evaluating the longitudinal sensor signal.

### EMBODIMENT 34

The detector device according to the preceding embodiment, wherein the evaluation device is designed to generate the at least one item of information on the longitudinal position of the object from at least one predefined relationship between a geometry of the illumination and a relative positioning of the object with respect to the optical detector.

### EMBODIMENT 35

The detector device according to any one of the two preceding embodiments, wherein the optical detector has a plurality of the longitudinal optical sensors, wherein the longitudinal optical sensors are stacked.

### EMBODIMENT 36

The detector device according to the preceding embodiment, wherein the longitudinal optical sensors are arranged such that the light beam illuminates all longitudinal optical sensors, wherein at least one longitudinal sensor signal is generated by each longitudinal optical sensor, wherein the evaluation device is adapted to normalize the longitudinal sensor signals and to generate the information on the longitudinal position of the object independent from an intensity of the light beam.

### EMBODIMENT 37

The detector device according to any one of the four preceding embodiments, wherein the evaluation device is adapted to generate the at least one item of information on the longitudinal position of the object by determining a diameter of the light beam from the at least one longitudinal sensor signal.

### EMBODIMENT 38

The detector device according to the preceding embodiment, wherein the evaluation device is adapted to compare the diameter of the light beam with known beam properties of the light beam in order to determine the at least one item of information on the longitudinal position of the object.

### EMBODIMENT 39

The detector device according to any one of the six preceding embodiments, wherein the longitudinal optical sensor is furthermore designed in such a way that the longitudinal sensor signal, given the same total power of the illumination, is dependent on a modulation frequency of a modulation of the illumination.

### EMBODIMENT 40

The detector device according to any one of the seven preceding embodiments, wherein the optical detector further comprises at least one transversal optical sensor, the transversal optical sensor being adapted to determine a transversal position of the light beam, the transversal position being a position in at least one dimension perpendicular an optical axis of the detector, the transversal optical sensor being adapted to generate at least one transversal sensor signal, wherein the evaluation device is further adapted to generate at least one item of information on a transversal position of the object by evaluating the transversal sensor signal.

### EMBODIMENT 41

The detector device according to the preceding embodiment, wherein the transversal optical sensor is a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes, wherein the transversal optical sensor has a sensor region, wherein the at least one transversal sensor signal indicates a position of the light beam in the sensor region.

### EMBODIMENT 42

The detector device according to the preceding embodiment, wherein electrical currents through the partial electrodes are dependent on a position of the light beam in the sensor region, wherein the transversal optical sensor is adapted to generate the transversal sensor signal in accordance with the electrical currents through the partial electrodes.

### EMBODIMENT 43

The detector device according to the preceding embodiment, wherein the detector device is adapted to derive the information on the transversal position of the object from at least one ratio of the currents through the partial electrodes.

### EMBODIMENT 44

The detector device according to any one of the three preceding embodiments, wherein the photo detector is a dye-sensitized solar cell.

### EMBODIMENT 45

The detector device according to any of the four preceding embodiments, wherein the first electrode at least partially is made of at least one transparent conductive oxide, wherein the second electrode at least partially is made of an electrically conductive polymer, preferably a transparent electrically conductive polymer.

### EMBODIMENT 46

A detector system, the detector system comprising at least one detector device according to any one of the preceding embodiments referring to a detector device, the detector system further comprising at least one object, wherein the at least one target device of the detector device is at least one of attached to the object, held by the object or integrated into the object.

### EMBODIMENT 47

A human-machine interface for exchanging at least one item of information between a user and a machine, wherein the human-machine interface comprises at least one detector device according to any of the preceding embodiments relating to a detector device, wherein the human-machine interface is designed to generate at least one item of geometrical information of the user by means of the detector device, wherein the human-machine interface is designed to assign to the geometrical information at least one item of information.

### EMBODIMENT 48

An entertainment device for carrying out at least one entertainment function, wherein the entertainment device comprises at least one human-machine interface according to the preceding embodiment, wherein the entertainment device is designed to enable at least one item of information to be input by a player by means of the human-machine interface, wherein the entertainment device is designed to vary the entertainment function in accordance with the information.

### EMBODIMENT 49

A tracking system for tracking the position of at least one movable object, the tracking system comprising at least one detector device according to any of the preceding embodiments referring to a detector device, the tracking system further comprising at least one track controller, wherein the track controller is adapted to track a series of positions of the object, each position comprising at least one item of information on a transversal position of the object at a specific point in time and at least one item of information on a longitudinal position of the object at a specific point in time.

### EMBODIMENT 50

A method for optically detecting at least one position of at least one object, the method using at least one target device according to any one of the preceding embodiments referring to a target device, the target device being at least one of attached to the object, held by the object or integrated into the object, the method further comprising detecting at least one light beam reflected by the target device, wherein the method further comprises determining at least one position of the object by determining at least one position of the target device.

### EMBODIMENT 51

The method according to the preceding embodiment, wherein the method further comprises illuminating the object with illumination light.

### EMBODIMENT 52

The method according to any one of the preceding method embodiments, the method comprising using a plurality of the target devices, wherein at least two of the target devices have different color conversion elements.

### EMBODIMENT 53

The method according to the preceding embodiment, wherein the at least one first color conversion element of a first target device is adapted to change a color of the light beam into a first color, wherein at least one second color conversion device of a second target device is adapted to change the color of the light beam into a second color, wherein the second color is different from the first color.

### EMBODIMENT 54

The method according to the preceding embodiment, the method further comprising distinguishing the target devices by the color of light beams reflected by these target devices.

### EMBODIMENT 55

The use of a target device according to any of the preceding embodiments relating to a target device, for a purpose of use, selected from the group consisting of: a distance measurement, in particular in traffic technology; a position measurement, in particular in traffic technology; an entertainment application; a security application; a human-machine interface application; a tracking application; an imaging application; a camera application; a manufacturing process; a packaging process.

### SHORT DESCRIPTION OF THE FIGURES

Further optional features and embodiments of the invention will be disclosed in more detail in the subsequent description of preferred embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a target device for use in optical detection of at least one object according to the present invention;

FIG. 2 shows a kit comprising a plurality of the target devices;

FIG. 3A shows an exemplary embodiment of a detector device;

FIG. 3B shows an example of a wavelength-sensitive element;

FIG. 3C shows a time development of a transmission; and

FIG. 4 shows an exemplary embodiment of a human-machine interface.

### DETAILED DESCRIPTION OF THE EMBODIMENTS

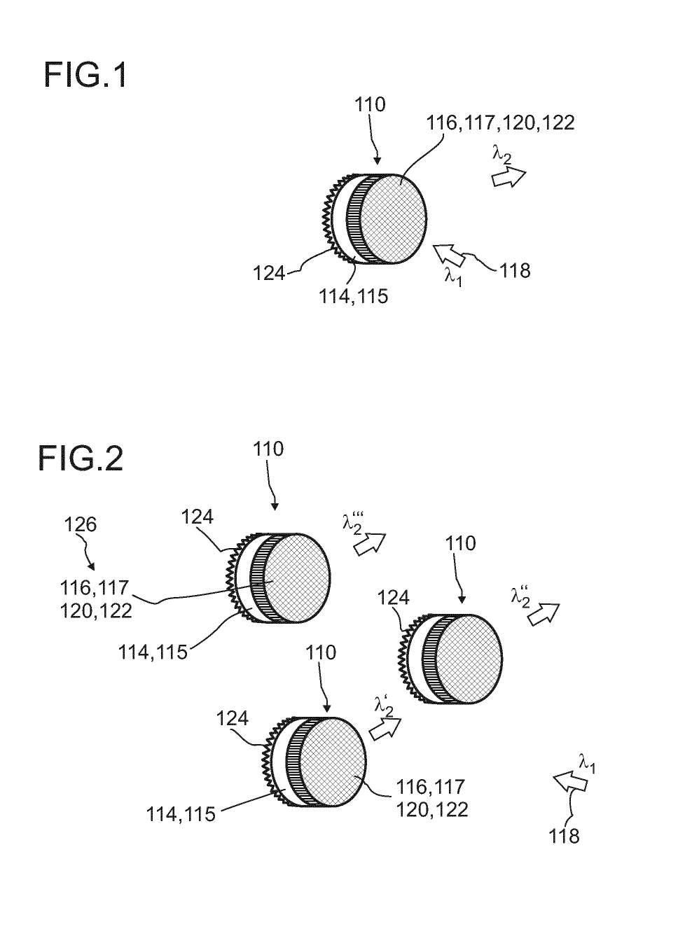

In FIG. 1 a target device 110 for use in optical detection of at least one object 112 according to the present invention is depicted. The target device 110 may have a diameter or equivalent diameter of 0.5 mm to 50 mm, preferably of 1.0 mm to 20 mm and more preferably of 5.0 mm to 10 mm. The target device 110 comprises at least one reflective element 114 and at least one color conversion element 116. In the embodiment shown in FIG. 1 the target device 110 may comprise a layer setup, having at least one reflective layer 115 forming the reflective element 114 and at least one color conversion layer 117 forming the color conversion element 116. The color conversion layer 117 may be disposed onto the reflective layer 115. Other embodiments are feasible, such as embodiments in which the reflective element 114 and the color conversion element 116 are fully or partially identical or fully or partially integrated into one and the same element, such as by mixing one or more color conversion material into one or more reflective materials and/or by providing both reflective particles and color conversion particles within one and the same layer, such as within one and the same layer of a matrix material.

The reflective element 114 is adapted for reflecting a light beam 118. The reflective element 114 may contain one or more reflective elements. For example, the reflective element 114 may contain one or more reflective elements selected from the group consisting of: angular reflectors; retro-reflectors; Luneburg-lenses; areal retro-reflectors. The reflective element 114 may comprise at least one flexible material, preferably a flexible material selected from the group consisting of: a flexible plastic material, a flexible textile, a glass bead tape, a micro-prismatic retro-reflective tape.

The color conversion element 116 is adapted to change at least one spectral property of the light beam 118 during reflecting the light beam 118. In general, the spectral property may be selected from the group consisting of: a color of the light beam; a peak wavelength of a spectrum of the light beam; a polarization of the light beam. In FIG. 1 an embodiment is shown, wherein the color conversion element 116 may be adapted to change the color of the light beam 118 during reflecting the light beam 118. In FIG. 1 the color of the light beam 118 to be changed by the color conversion element 116 is denoted as λ₁. The changed color of the reflected light beam 118 is denoted as λ₂. The color conversion element 116 may be one of a down-conversion color conversion element 120 and an up-conversion color conversion element 122. The down-conversion color conversion element 120 may be adapted for shifting the color λ₁ of the light beam 118 towards longer wavelengths, whereas the up-conversion color conversion element 122 may be adapted to shift the color λ₁ of the light beam 118 towards lower wavelengths. The down-conversion color conversion element 120 may comprise at least one of: a perylene dye; a naphthalene dye, in particular a naphthalene benzimidazole; a squaraine dye; a diketopyrrolopyrrole dye; an acridine dye; a pyrene dye; triarylamines; rhodamines; fluoresceines; a rare-earth metal complex; a transition metal complex; an inorganic metal oxide pigment; an inorganic absorber; an inorganic pigment; a phthalocyanine dye; a porphyrine dye; an organic pigment; other fluorescent dyes and pigments known to the skilled person. The up-conversion color conversion element 122 may comprise at least one rare earth metal complex.

The color conversion element 116 may comprise at least one dye. For example, the dye may be selected from the group consisting of an organic dye and an inorganic dye. The color conversion element may comprise at least one color converter, specifically at least one color converter as disclosed in WO 2012/152812A1 and/or disclosed in WO 2012/168395 A1.

The color conversion element 116 may comprise at least one matrix element and at least one color conversion material embedded into the matrix element. The matrix element may comprise at least one transparent matrix material. Specifically, the matrix element may comprise at least one matrix material selected from the group consisting of: a resin; a polymer, preferably a polymer selected from the group consisting of polyethylene-terephthalate (PET); polystyrene; polyurethane, a synthetic or natural rubber, a polyester, a polycarbonate, a poly-acrylate, a polyamide, a silicone, a thermoplastic polymer, an elastic polymer; glass; silicon dioxide; a salt; an amorphous organic or inorganic phase; a crystalline organic or inorganic phase; a glue such as an epoxy glue. The target device 110 may comprise at least one light-scattering material dispersed into the matrix material. For example, the light-scattering material may comprise inorganic particles, specifically titanium dioxide. The color conversion element 116 may comprise one or more of: an organic color conversion element, more preferably a polymer color conversion element; a color conversion pigment; a color conversion phosphor.

Further, the target device 110 may comprise at least one attachment device 124 adapted for attaching the target device 110 to the object 112. For example, the attachment device 124 may comprise at least one element selected from the group consisting of: an adhesive surface; a Velcro fastener; a strap; a hook; a clamp; a magnet; a ribbon; a belt; a button; a zipper; a rubber band; a suction cup; a fastener selected from the group consisting of: a clip, a clamp, a pin, a snap fastener, another kind of fastener known to the skilled person.

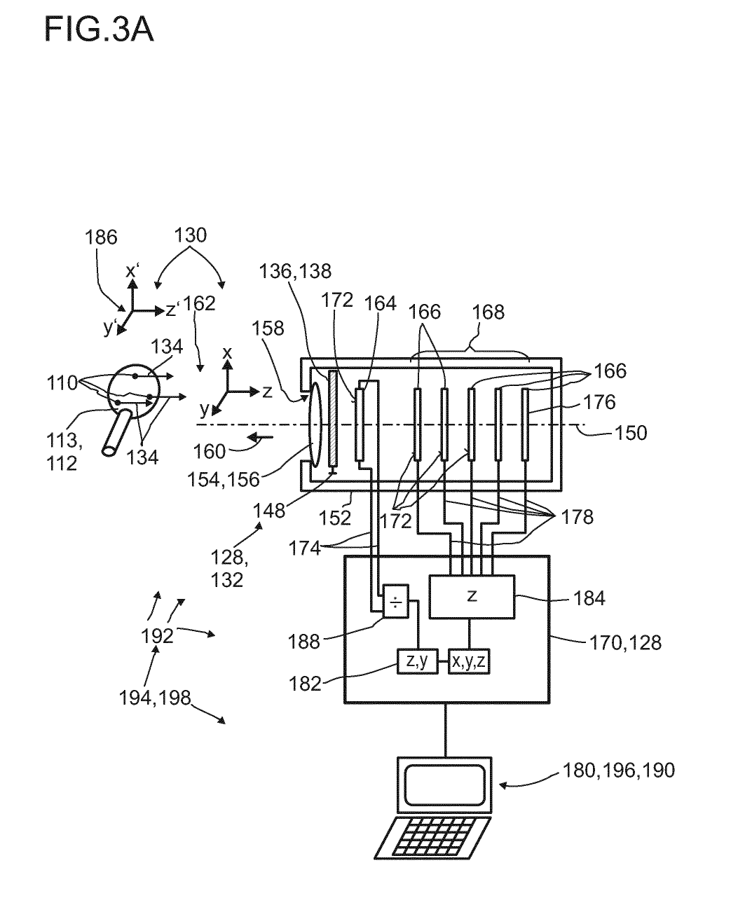

In FIG. 2 a kit 126 comprising a plurality of the target devices 110 is depicted. At least two of the target devices 110 may have different color conversion elements 116. In this embodiment, the kit 126 may comprise three target devices 110. The light beam 118 before impinging on the plurality of target devices 110 may have a color λ₁. Each of the three target devices 110 comprised in the kit 126 may have a different color conversion element 116. Thus, each of the color conversion elements 116 may be adapted to change the color of the light beam 118 to a different wavelength (λ₂′, λ₂″, λ₂′″) during reflecting the light beam 118.

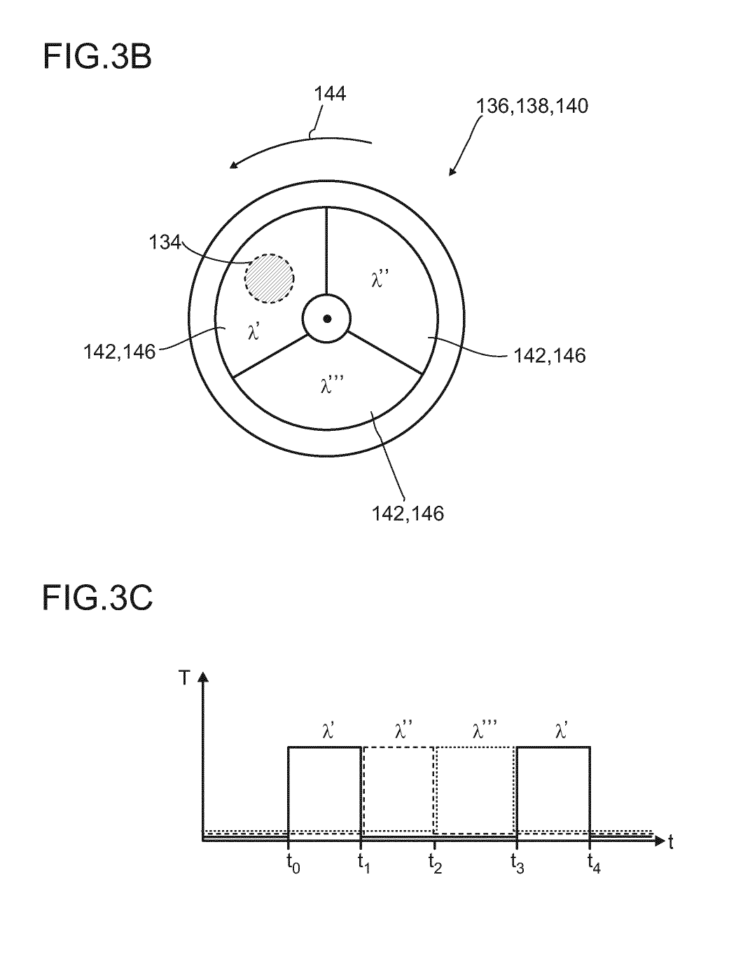

FIG. 3A illustrates, in a highly schematic illustration, an exemplary embodiment of a detector device 128, which forms a component of a detector system 130 according to the present invention, for detecting at least one object 112. The detector device 128 comprises at least one target device 110, being at least one of attached to the object 112, held by the object 112 or integrated into the object 112. The detector device 128 may comprise a plurality of the target devices 110, wherein at least two of the target devices 110 may have different color conversion elements 116.

The object 112 is detectable by the at least one optical detector 132. In the embodiment shown in FIG. 3A, the object 112 may be a sports device, in particular a racket. In this exemplary embodiment, the object 112 may form a control element 113 which may be held and/or handled by a user (not shown). The object 112 comprises at least one target device 110. Preferably, the object 112 may comprise a plurality of target devices 110. Preferably, in this embodiment and in other embodiments, the target devices 110 are located at representative positions at the object 112, such that a position of the target devices 110 is a representative measure for determining at least one orientation of the object 112. Thus, generally, in case three or more target devices 110 are present, the target devices 110 preferably are positioned such that they may not be interconnected by one straight line. Thus, the target devices 110 may span a plane. Preferably, at least two or at least three of the target devices 110 are located on a surface of the object 112 facing towards the optical detector 132. In case more than three target devices 110 are provided, it is further preferred that target devices 110 are positioned on both sides of the object 112, such as by positioning at least two or at least three target devices 110 on each major surface of the object 112. FIG. 3A shows an embodiment, wherein the object may comprise three target devices 110. At least two of the target devices 110 may have different color conversion elements 116. Each of the color conversion elements 116 may be adapted to change the color of the light beam 118 to a different wavelength (λ₂′, λ₂″, λ₂′″) during reflecting the light beam 118. Thus, the light beam 118 may be reflected by each of the three target devices 110. Each of the reflected light beams 134 may have a different wavelength. The detector device 128 further comprises the at least one optical detector 132 for detecting at least one light beam 134 reflected by the target device 110. The reflected light beams 134, each having different color (λ₂′, λ₂″, λ₂′″), may be detected by the optical detector 132. The detector device 128 is adapted for determining at least one position of the object by determining at least one position of the target device 110.

The detector device 128 may comprise at least one color-sensitive element 136. The color-sensitive element 136 may be selected from the group consisting of: a filter, preferably a filter wheel; a prism; a grating; a dichroitic mirror; a color-sensitive detector element. The detector device 128 is adapted to distinguish the target devices 110 by the color of the light beams 134 reflected by the target devices 110. The detector device 128 may be adapted to generate detector signals for the different light beams 134 having different colors and originating from different target devices 110 sequentially and/or in parallel. In general, it is feasible that for generating detector signals for the different colors in parallel, the light beams 134 entering the detector device 128 may be separated according to their color, in order to separate components of the light beam 134 according to their origin, i.e. according to the target device 110 from which each of the light beams 134 originates. Within the detector device 128, a plurality of partial light paths may be present, each light path corresponding to a specific color. For splitting the light path into the plurality of partial light paths, at least one wavelength-sensitive element may be used, such as one or more of a prism, a grating or a dichroitic mirror. At least one optical sensor may be in each of the partial light paths, in order to generate at least one detector signal for each of the partial light paths. FIG. 3A shows an alternative embodiment, wherein detector signals for the different colors may be generated sequentially. Within the detector device 128 at least one wavelength-sensitive element 138 may be used, which is adapted to sequentially influence the light beam 134 and/or sequentially separate the light beam 134 entering the detector device 128.

An example of the wavelength-sensitive element 138, a rotating filter wheel 140, is depicted in FIG. 3B. The rotating filter wheel 140 may have filter segments 142 having different transmission properties, such as different colors, different absorption properties or the like. The rotating filter wheel 140 may rotate in a rotation direction 144. Each cycle of rotation of the filter wheel 140 may be split into time segments 146, wherein each segment may correspond to a different color. In FIG. 3B an embodiment is shown, wherein the rotating filter wheel 140 may have three filter segments 142. A first time segment 146 may correspond to the color λ′, a second time segment 146 may correspond to the color λ″ and a third time segment 146 may correspond to the color λ′″. The light beam 134 reflected by different target devices 110 may have components with different colors λ′, λ″ and λ′″. The reflected light beam 134 may impinge on the rotating filter wheel 140. Components, having different colors, of the reflected light beam 134 may be separated sequentially. In FIG. 3C a time development of the transmission T is shown. The time development of the component of the reflected light beam 134 corresponding to the color λ′ is shown by the solid line. During a time interval between times t₁ to t₂ the reflected light beam 134 may impinge on a segment 146 corresponding to the color λ′. Thus, during this time interval, the transmission of the reflected light beam 134 corresponding to the color λ′ shows a maximum. Whereas at time intervals, in which the light beam 134 may impinge on segments 146 corresponding to colors λ″ and λ′″, no light of the component of the reflected light beam 134 corresponding to the color λ′ may pass the filter. In this time intervals, the transmission may be around an offset value and/or around zero. The dashed line and the dotted line show the time development of the component of the reflected light beam 134 corresponding to the color λ″ and λ″, respectively. The light beam 134 may impinge on the second segment 146 between times t₁ and t₂ and on the third time segment 146 between times t₂ and t₃. The cycle of rotation may start anew at time t₃, so that between times t₃ and t₄ again the transmission of the reflected light beam 134 corresponding to the color λ′ has a maximum.

Referring again to FIG. 3A, the optical detector 132 may be placed behind the wavelength-sensitive element 138, in order to generate at least one combined detector signal. The combined detector signal may be evaluated in a time-resolved fashion, such as by using a phase sensitive detection. Thus, the combined detector signal may be split into partial detector signals corresponding to the different time segments 146 and to different colors of the light beam 134 reflected by different target devices 110.

The optical detector 132 may comprise a plurality of optical sensors 148, which, in the specific embodiment, are all stacked along an optical axis 150 of the optical detector 132. Specifically, the optical axis 150 may be an axis of symmetry and/or rotation of the setup of the optical sensors 148. The optical sensors 148 may be located inside a housing 152. Further, at least one transfer device 154 may be comprised, such as one or more optical systems, preferably comprising one or more lenses 156. An opening 158 in the housing 152, which, preferably, is located concentrically with regard to the optical axis 150, preferably defines a direction of view 160 of the optical detector 132. A coordinate system 162 may be defined, in which a direction parallel or antiparallel to the optical axis 150 is defined as a longitudinal direction, whereas directions perpendicular to the optical axis 150 may be defined as transversal directions. In the coordinate system 162, symbolically depicted in FIG. 3A, a longitudinal direction is denoted by z and transversal directions are denoted by x and y, respectively. Other types of coordinate systems 162 are feasible.

The optical sensors 148 may comprise at least one transversal optical sensor 164 and, in this embodiment, a plurality of longitudinal optical sensors 166. The longitudinal optical sensors 166 form a longitudinal optical sensor stack 168. In the embodiment shown in FIG. 3A, five longitudinal optical sensors 166 are depicted. It shall be noted, however, that embodiments having a different number of longitudinal optical sensors 166 are feasible.

The transversal optical sensor 164 comprises a sensor region 172, which, preferably, is transparent to light beams 134 travelling from the target devices 110 to the optical detector 132. The transversal optical sensor 164 may be a photo detector, in particular a dye-sensitized solar cell. The transversal optical sensor 164 may optionally be adapted to determine a transversal position of the light beams 134 in one or more transversal directions, such as in direction x and/or in direction y. Therein, embodiments are feasible in which a transversal position in only one transversal direction is determined, embodiments in which transversal positions in more than one transversal direction are determined by one and the same transversal optical sensor 164, and embodiments in which a transversal position in a first transversal direction is determined by a first transversal optical sensor and wherein at least one further transversal position in at least one further transversal direction is determined by at least one further transversal optical sensor.

The detector device 128, besides the optical detector 132, comprises an evaluation device 170. The evaluation device 170 may fully or partially be integrated into the optical detector 132 and/or may fully or partially be designed as a separate device. The at least one optional transversal optical sensor 164 may be adapted to generate at least one transversal sensor signal. This transversal sensor signal may be transmitted by one or more transversal signal leads 174 to the evaluation device 170. The evaluation device 170 may be adapted to generate at least one item of information on a transversal position of the object 112 by evaluating the transversal sensor signal.

The longitudinal optical sensors 166 each comprise at least one sensor region 172. Preferably, one, more or all of the longitudinal optical sensors 166 are transparent. In general, it is feasible that one or more longitudinal optical sensors 166 are fully or partially intransparent. E.g. a last longitudinal optical sensor 176 of the longitudinal optical sensor stack 168, i.e. the longitudinal optical sensor 166 on the side of the stack 168 furthest away from the object 112 may fully or partially be intransparent.

Each of the longitudinal optical sensors 166 may be designed to generate at least one longitudinal sensor signal in a manner dependent on an illumination of the respective sensor region 172 by the light beam 134. The longitudinal sensor signals, given the same total power of the illumination, may be dependent on a beam cross-section of the light beam 134 in the respective sensor region 172. Via one or more longitudinal signal leads 178, the longitudinal sensor signals may be transmitted to the evaluation device 170. The evaluation device 170 may be designed to generate at least one item of information on at least one longitudinal position of the object 112 by determining a diameter of the light beam 134 from the at least one longitudinal sensor signal. The evaluation device 170 may be adapted to compare the diameter of the light beam 134 with known beam properties of the light beam in order to determine the at least one item of information on the longitudinal position of the object 112.

The evaluation device 170 may be designed to determine the longitudinal coordinates of the target devices 110 by evaluating the longitudinal sensor signals. The evaluation device 170 may be designed to determine the longitudinal coordinates of the target devices 110 from at least one predefined relationship between the geometry of the illumination and a relative positioning of the respective target device 110 with respect to the optical detector 132.

The longitudinal optical sensors 166 may be arranged such that the light beam 134 traveling from the target devices 110 to the optical detector 132 illuminates all longitudinal optical sensors 166. The at least one longitudinal sensor signal may be generated by each longitudinal optical sensor 166. The evaluation device 170 may be adapted to normalize the longitudinal sensor signals and to generate the at least one longitudinal coordinate of the respective target device 110 independent from an intensity of the light beam, at least for intensities>0.

The evaluation device 170 can comprise in particular at least one data processing device 180, in particular an electronic data processing device. The data processing device 180 specifically can be designed to generate the at least one item of information on the transversal position of the target device 110 by evaluating the at least one transversal sensor signal and to generate the at least one item of information on the longitudinal position of the target device 110 by evaluating the at least one longitudinal sensor signal. Thus, the evaluation device 170 may be designed to use the at least one transversal sensor signal and the at least one longitudinal sensor signal as input variables and to generate the items of information on the transversal position and the longitudinal position of the target device 110 by processing these input variables. Thereby, a position of the at least one target device 110 may be calculated by the evaluation device 170. In case a plurality of the target devices 110 is provided, the position of each of the target devices 110 may be calculated.

The evaluation device 170 may comprise one or more electronic devices and/or one or more software components, in order to evaluate the longitudinal sensor signal and the transversal signals, which is symbolically denoted by transversal evaluation unit 182 (denoted by “xy”) and longitudinal evaluation unit 184 (denoted by “z”). By combining results derived by these evolution units 182, 184, a position information, preferably a three-dimensional position information, may be generated (denoted by “x, y, z”), such as for each of the target devices 110. In the embodiment shown in FIG. 3A three target devices 110 are present. The longitudinal coordinates of the three target devices 110 may be used to determine the orientation of the object 112. The evaluation device 170 may be adapted for using the predetermined coordinates of the target devices 110 in a coordinate system of the object 186, and by determining the longitudinal coordinates of the target devices 110 in the coordinate system 162 of the optical detector 132, to perform a coordinate transformation and/or to determine orientation angles. The evaluation device 170 may be adapted to use one or more transformation algorithms for transforming the longitudinal coordinates of the target devices 110 and, optionally, one or more additional items of information, into at least one item of information regarding the orientation of the object 112 in the coordinate system of the optical detector 132.

The evaluation device 170 may fully or partially be integrated into the detector 132 and/or may fully or partially be part of the data processing device 180 and/or may comprise one or more data processing devices 180. The evaluation device 170 may be fully or partially integrated into the housing 152 and/or may fully or partially be embodied as a separate device which is electrically connected in a wireless or wire-bound fashion to the optical sensors 148. The evaluation device 170 may further comprise one or more additional components, such as one or more electronic hardware components and/or one or more software components, such as one or more measurement units (not depicted in FIG. 3A) and/or one or more transformation units 188. Symbolically, in FIG. 3A, one optional transformation unit 188 is depicted which may be adapted to transform at least two transversal sensor signals into a common signal or common information.

FIG. 3A, further illustrates the detector system 130, which, besides the detector device 128, further comprises the at least one object 112, with the target devices 110 attached thereto and/or integrated therein. Further, since the object 112, specifically the control element 113, may be handled by a user in order to transmit at least one item of information to a machine 190, specifically an data processing device 180. FIG. 3A also illustrates a schematic embodiment of a human-machine interface 192 according to the present invention. Since, for example, the human-machine interface 192 may be used for computer games and transmitting control commands to an data processing device 180 adapted for gaming, the data processing device 180 in conjunction with the human-machine interface 192 may also form an illustrative example of an entertainment device 194.

Further, the data processing device 180, in conjunction with the detector device 128, may be adapted to track an orientation of the object 112. Thus, the data processing device 180 may act as a track controller 196 and, thus, the data processing device 180, the detector device 128 and the track controller 196 may form an exemplary embodiment of a tracking system 198 according to the present invention.

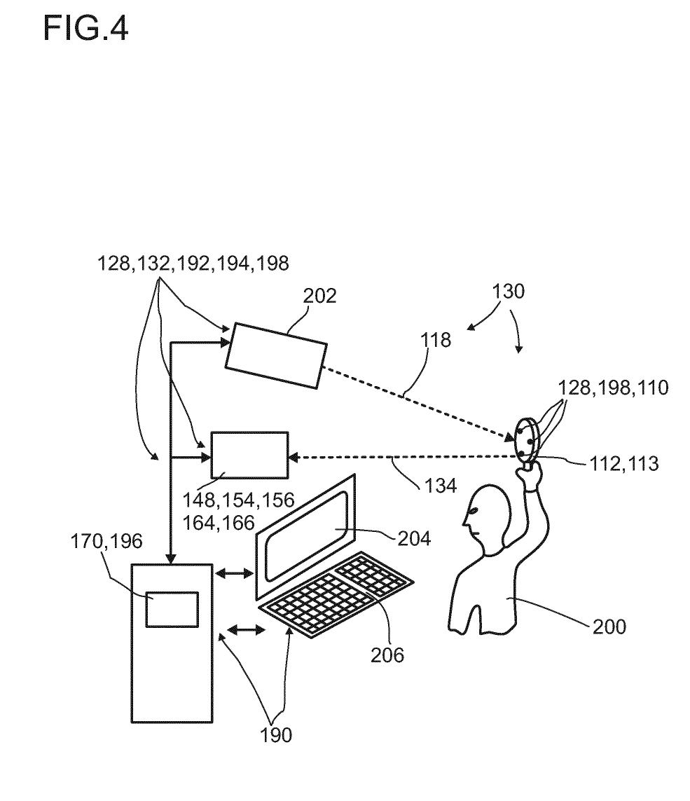

In FIG. 4, an exemplary embodiment of a human-machine interface 192 according to the present invention, which can simultaneously also be embodied as an exemplary embodiment of an entertainment device 194 according to the invention or which can be a constituent part of such an entertainment device 194, is depicted. Further, the human-machine interface 192 and/or the entertainment device 194 may also form an exemplary embodiment of the tracking system 198 adapted for tracking an orientation of a user 200 and/or of one or more body parts of the user 200, and, optionally, for tracking a position of the user 200 and/or of the one or more body parts of the user 200. Thus, a motion of one or more of the body parts of the user 200 may be tracked. Generally, for the most components of the named systems and devices, reference may be made to the definitions given above with regard to FIG. 3A.

By way of example, at least one detector device 128 with at least one optical detector 132 according to the present invention can once again be provided, for example, in accordance with one or more of the embodiments described above, with one or a plurality of optical sensors 148, which may comprise one or more transversal optical sensors 164 and one or more longitudinal optical sensors 166. Further elements of the optical detector 132 can be provided, which are not illustrated in FIG. 4, such as, for example, elements of an optional transfer device 154. For a potential embodiment, reference may be made to FIG. 3A. Furthermore, one or a plurality of illumination sources 202 may be provided. Generally, with regard to these possible embodiments of the optical detector 132, reference can be made for example to the description above.

The human-machine interface 192 can be designed to enable an exchange of at least one item of information between a user 200 and a machine 190. For example, a unidirectional or bidirectional exchange of control commands, and/or information may be performed by using the human-machine interface 192. The machine 190 can comprise, in principle, any desired device having at least one function which can be controlled and/or influenced in some way. At least one evaluation device 170 of the at least one detector device 128 and/or a part thereof can, as indicated in FIG. 4, be wholly or partially integrated into said machine 190, but can, in principle, also be formed fully or partially separately from the machine 190.

The human-machine interface 192 can be designed for example to generate, by means of the detector device 128, at least one item of geometrical information of the user 200, and can assign the geometrical information at least to one item of information, in particular at least one control command. For this purpose, the human-machine interface 192 is adapted to determine at least one orientation of the user 200, by using the detector device 128. In this exemplary embodiment, as outlined above, a control element 113 is used. The control element 113 may have in this embodiment three target devices 110 which are at least one of integrated into or attached to the control element 113, wherein the control element 113 acts as an object 112 which may be handled by the user 200. Thus, by determining the orientation of the control element 113, an orientation of at least one body part of the user 200 may be determined, such as the position of an arm and/or a hand holding the control element 113. Additionally or alternatively, other possibilities are feasible, such as the target devices 110 being held by and/or attached to the user 200 in a different way.

By way of example, by means of the detector device 128, a movement and/or a change in orientation of the user 200 and/or a body part of the user 200 can be identified. For example, as indicated in FIG. 4, a hand movement and/or a specific hand posture of the user 200 may be detected. Additionally or alternatively, other types of geometrical information of the user 200 may be detected by the detector device 128 having one or more optical detectors 132. In this embodiment, the object 112 may be a sports device in particular a racket. The object 112 may comprise three target devices 110 attached to the racket.

The setup and/or the machine 190 can furthermore comprise one or a plurality of further human-machine interfaces, which need not necessarily be embodied according to the invention, for example, as indicated in FIG. 4, at least one display 204 and/or at least one keyboard 206. Additionally or alternatively, other types of human-machine interfaces may be provided. The machine 190 can, in principle, be any desired type of machine or combination of machines, such as a personal computer.

The at least one evaluation device 170 and/or one or more parts thereof may further function as a track controller 196 of the tracking system 198. Additionally or alternatively, one or more additional track controllers 196 may be provided, such as one or more additional data evaluation devices. The track controller 196 may be or may comprise one or more data memories, such as one or more volatile and/or non-volatile memories. In this at least one data memory, a plurality of subsequent orientations and/or positions of one or more objects 112 or parts of an object 112 and/or of the user 200 and/or one or more body parts of the user 200 may be stored, in order to allow for storing a past trajectory. Additionally or alternatively, a future trajectory may be predicted, such as by calculation, extrapolation or any other suitable algorithm. As an example, a past trajectory of an object 112 or a part thereof may be extrapolated to future values, in order to predict at least one of a future orientation and/or future position and/or a future trajectory of the object 112 or a part thereof.

In the context of an entertainment device 194 said machine 190 can be designed for example to carry out at least one entertainment function, for example at least one game, in particular with at least one graphical display on the display 204 and, optionally, a corresponding audio output. The user 200 can input at least one item of information, for example via the human-machine interface 192 and/or one or more other interfaces, wherein the entertainment device 194 is designed to alter the entertainment function in accordance with the information. By way of example, specific movements of one or more virtual articles, for example of virtual persons in a game and/or movements of virtual vehicles in a game, may be controlled by means of corresponding movements of the user 200 and/or one or more body parts of the user 200 and/or the at least one control element 113, which, in turn, may be recognized by the detector device 128. Other types of control of at least one entertainment function by the user 200, by means of the at least one detector device 128, are also possible.

### LIST OF REFERENCE NUMBERS

110 target device
112 object
113 control element
114 reflective element
115 reflective layer
116 color conversion element
117 color conversion layer
118 light beam
120 down-conversion color conversion element
122 up-conversion color conversion element
124 attachment device
126 kit
128 detector device
130 detector system
132 optical detector
134 reflected light beam
136 color-sensitive element
138 wavelength-sensitive element
140 rotating filter wheel
142 filter segments
144 rotation direction
146 time segments
148 optical sensors
150 optical axis
152 housing
154 transfer device
156 lens
158 opening
160 direction of view
162 coordinate system
164 transversal optical sensor
166 longitudinal optical sensor
168 longitudinal optical sensor stack
170 evaluation device
172 sensor region
174 transversal signal lead
176 last longitudinal optical sensor
178 longitudinal signal lead
180 data processing device
182 transversal evaluation unit
184 longitudinal evaluation units
186 coordinate system of the object
188 transformation unit
190 machine
192 human-machine interface
194 entertainment device
196 track controller
198 tracking system
200 user
202 illumination source
204 display
206 keyboard

1: A target device, being adapted for at least one of being integrated into an object, being held by the object or being attached to the object, the target device having at least one reflective element for reflecting a light beam, the target device further having at least one color conversion element, the color conversion element being adapted to change at least one spectral property of the light beam during reflecting the light beam.

2: The target device according to the preceding claim, wherein the color conversion element is adapted to change a color of the light beam during reflecting the light beam.

3: The target device according to the preceding claim, wherein the color conversion element is one of a down-conversion color conversion element adapted for shifting the color of the light beam towards longer wavelengths and up-conversion color conversion element adapted for shifting the color of the light beam towards lower wavelengths.

4: The target device according to claim 1, wherein the color conversion element comprises at least one dye.

5: The target device according to claim 1, wherein the target device comprises a layer setup having at least one reflective layer forming the reflective element and at least one color conversion layer forming the color conversion element, the color conversion layer being disposed onto the reflective layer, the color conversion layer comprising the at least one color conversion element.

6: The target device according to claim 1, wherein the reflective element comprises at least one flexible material.

7: The target device according to claim 1, wherein the color conversion element comprises at least one matrix element and at least one color conversion material embedded into the matrix element.

8: The target device according to claim 1, wherein the target device further comprises at least one attachment device adapted for attaching the target device to at least one object.

9: A kit comprising a plurality of the target devices according to claim 1, wherein at least two of the target devices have different color conversion elements.

10: An object detectable by at least one optical detector, the object comprising at least one target device according to claim 1, wherein the target device is at least one of integrated into the object, held by the object or attached to the object.

11: A detector device, comprising at least one target device according to claim 1, the target device being at least one of attached to the object, held by the object or integrated into the object, the detector device further comprising at least one optical detector adapted for detecting at least one light beam reflected by the target device, wherein the detector device is adapted for determining at least one position of the object by determining at least one position of the target device.

12: The detector device according to the preceding claim, comprising a plurality of the target devices, wherein at least two of the target devices have different color conversion elements, wherein the at least one first color conversion element of a first target device is adapted to change a color of the light beam into a first color, wherein at least one second color conversion device of a second target device is adapted to change the color of the light beam into a second color, wherein the second color is different from the first color, wherein the detector device further comprises at least one color-sensitive element, wherein the detector device is adapted to distinguish the target devices by the color of light beams reflected by these target devices.

13: A detector system, the detector system comprising at least one detector device according to claim 11, the detector system further comprising at least one object, wherein the at least one target device of the detector device is at least one of attached to the object, held by the object or integrated into the object.

14: A human-machine interface, comprising at least one detector device according to claim 11, wherein the human-machine interface is designed to generate at least one item of geometrical information of the user with the detector device, wherein the human-machine interface is designed to assign to the geometrical information at least one item of information.

15: An entertainment device, comprising at least one human-machine interface according to the preceding claim, wherein the entertainment device is designed to enable at least one item of information to be input by a player by means of the human-machine interface, wherein the entertainment device is designed to vary the entertainment function in accordance with the information.

16: A tracking system, comprising at least one detector device according to claim 11, the tracking system further comprising at least one track controller, wherein the track controller is adapted to track a series of positions of the object, each position comprising at least one item of information on a transversal position of the object at a specific point in time and at least one item of information on a longitudinal position of the object at a specific point in time.

17: A method for optically detecting at least one position of at least one object, the method comprising optically detecting the at least one position of the at least one object with the at least one target device according to claim 1, the target device being at least one of attached to the object, held by the object or integrated into the object,
the method further comprising detecting at least one light beam reflected by the target device, wherein the method further comprises determining at least one position of the object by determining at least one position of the target device.

18: The method according to claim 17, wherein the optically detecting of the at least one target device is selected from the group consisting of: a distance measurement; a position measurement; an entertainment application; a security application; a human-machine interface application; a tracking application; an imaging application; a camera application; a manufacturing process; and a packaging process.

19: The target device according to claim 6, wherein the reflective element comprises at least one flexible material selected from the group consisting of: a flexible plastic material, a flexible textile, a glass bead tape, and a micro-prismatic retro-reflective tape.
